(19) United States
(12) Patent Application Publication
(10) Pub. No.: US 2007/0260495 A1
(43) Pub. Date: Nov. 8, 2007

(54) Software Architecture and Database for Integrated Travel Itinerary and Related Reservation System Components

(76) Inventors: Scott Mace, Santa Cruz, CA (US); Bart Alan Meltzer, Watsonville, CA (US); Joseph Donovan, Felton, CA (US); Sean Gallavan, Santa Cruz, CA (US)

Correspondence Address: HAYNES BEFFEL & WOLFELD LLP, P O BOX 366, HALF MOON BAY, CA, 94019, US

(21) Appl. No.: 11/552,099

(22) Filed: Oct. 23, 2006

Related U.S. Application Data
(60) Provisional application No. 60/728,841, filed on Oct. 21, 2005.

(51) Int. Cl. G06Q 10/00

(52) U.S. Cl. 705/5; 709/201

(57) ABSTRACT

The present disclosure relates to software and database architectures and features that are adapted to VRMs and computer savvy users who would otherwise go to VRMs. In particular, it relates to an updateable itinerary data structure, method and database system. It further relates to server-side tracking of click-throughs by users presented with advertising, with options for tracking advertising impact beyond making a reservation to fulfillment. It also relates to a search engine optimized technology that integrates dynamic inventory into pages that appear to search indexing bots as static pages, thereby increasing indexing exposure. It provides a tool and method to convert HTML web pages with frames or IFrames into ASP web pages with code behind pages supporting added features.

### PRIORITY CLAIM

This application claims the benefit of provisional U.S. Patent Application No. 60/728,841, filed on Oct. 21, 2005. The provisional application is hereby incorporated by reference.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### REFERENCE TO COMPUTER PROGRAM LISTING APPENDIX

A computer program listing appendix consisting of “*.txt” files submitted electronically accompanies this application and is incorporated by reference. The computer program listing appendix includes the following electronically submitted files:

| | | |
|---|---|---|
| ConvertFiles-ASPX-CS.txt | 69080 bytes | created Oct. 22, 2006 |
| ConvertFiles-ASPX.txt | 5041 bytes | created Oct. 22, 2006 |
| RooPageCore-CS.txt | 67840 bytes | created Oct. 22, 2006 |
| Unit34-ASPX.txt | 6909 bytes | created Oct. 22, 2006 |

The file sizes given are as reported by the PTO's upload utility.

### BACKGROUND OF THE INVENTION

The present disclosure relates to software and database architectures and features that are adapted to VRMs and computer savvy users who would otherwise go to VRMs. In particular, it relates to an updateable itinerary data structure, method and database system. It further relates to server-side tracking of click-throughs by users presented with advertising, with options for tracking advertising impact beyond making a reservation to fulfillment. It also relates to a search engine optimized technology that integrates dynamic inventory into pages that appear to search indexing bots as static pages, thereby increasing indexing exposure. It provides a tool and method to convert HTML web pages with frames or IFrames into ASP web pages with code behind pages supporting added features.

Software systems used in the vacation travel business have become increasingly sophisticated over time. Some of the early software systems were designed to handle online reservations for airlines. In the early software era, the systems typically were custom-built and mainframe hosted.

Software technology has evolved. Servers typically have replaced mainframes and PCs have replaced terminals. A travel-related offer will be published to many servers that amalgamate offers from different sources, instead of being offered exclusively through a proprietary system. A user who books online accesses a server that presents many choices. Online portals are operated by Expedia, Travelocity, Yahoo and others. The airlines are pushing travelers to book online, instead of calling their travel agent or even calling the airline.

One segment for which software development has significantly lagged the travel industry is known as vacation rental management, or VRM for short. “Try Kona”® is an example of a VRM that lists six properties in Kailua Kona, Hi. The Try Kona properties include oceanfront, resort and golf course homes and condominiums. A traveler who books with Try Kona often begins with availability of a unique property and builds a vacation around that availability. The traveler calls the VRM and speaks to someone knowledgeable of the properties listed, someone who can help them with more than just a rental, who can help them put together their vacation. The VRM may work with manual records or a simple reservation software package. Some vacation activities may be manually arranged, calling a local vendor who is too small to have any kind of online reservation capability.

In general, VRMs are small and do not have the resources or sophisticated software of a hotel chain. Even if they had the same software as a hotel chain, it would not be well adapted to their market, which thrives on personal assistance and packaging vacations, rather than just booking rooms. A VRM would benefit from a software architecture and system that provided real time access to and filtering of just the right information for servicing customers. Similarly, a typical VRM customer with some computer savvy might benefit from a consumer-facing version of the system that a telephone answering VRM would find helpful.

Accordingly, an opportunity arises to develop software and database architectures and features that are adapted to VRMs and computer savvy users who would otherwise go to VRMs. Increased efficiency in real time, online service that originates on different computer systems could result.

### SUMMARY OF THE INVENTION

The present disclosure relates to software and database architectures and features that are adapted to VRMs and computer savvy users who would otherwise go to VRMs. In particular, it relates to an updateable itinerary data structure, method and database system. It further relates to server-side tracking of click-throughs by users presented with advertising, with options for tracking advertising impact beyond making a reservation to fulfillment. It also relates to a search engine optimized technology that integrates dynamic inventory into pages that appear to search indexing bots as static pages, thereby increasing indexing exposure. It provides a tool and method to convert HTML web pages with frames or IFrames into ASP web pages with code behind pages supporting added features. Particular aspects of the present invention are described in the claims, specification and drawings.

### BRIEF DESCRIPTION OF THE DRAWINGS

FIG. 1 illustrates a software and database architecture centered around a travel services (“TS”) hub server.

FIGS. 2-3 depict alternative database structures for maintaining unit information.

FIG. 4 is a high-level block diagram of the rental ad connector software component.

FIG. 5 provides further detail of the alternative interactions between a user or a user's agent or representative leading to generation of an integrated itinerary data structure.

FIG. 6 illustrates the role of an updatable integrated itinerary.

FIG. 7 depicts interaction with three basic types of online inquiry/booking web page forms.

FIG. 8 is a high level flowchart of persisting and updating an updatable itinerary data structure that records online negotiations between a consumer and multiple distinct travel-related vendors.

FIG. 9 is a content mock up of a chronologically organized, formatted version of items in the updatable itinerary data structure.

FIG. 10 shows details of possible information available for one of the items in updatable itinerary data structure.

FIG. 11 is an alternate embodiment of the updatable integrated itinerary, after addition of just a first item.

FIG. 12 is a high-level block diagram of dynamic packaging and pricing of travel.

FIG. 13 is a high-level flowchart of tracking a user from click-through to fulfillment.

FIG. 14 is a high-level block diagram of equipment used for integrating into a website at a first address catalog content hosted at a second address.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

Software and Database Architecture for VRMs

Vacation rentals are a separate market with distinctly different needs, distinct from business travel. Vacation rentals are more unique than business hotel rooms. Travel typically is built around the vacation rental, rather than the flight reservations or a business meeting. A package is assembled and purchased, once two or three basic elements fit together, such as the rental and the travel arrangements. VRM companies are sometimes interested in an integrated solution, which begins with backend relations with vendors and service operations and extends to booking, or in integration of marketing and online booking capabilities with their existing websites and backend systems. Extension from backend relations to an integrated, multi-vendor integrated itinerary is new and unique.

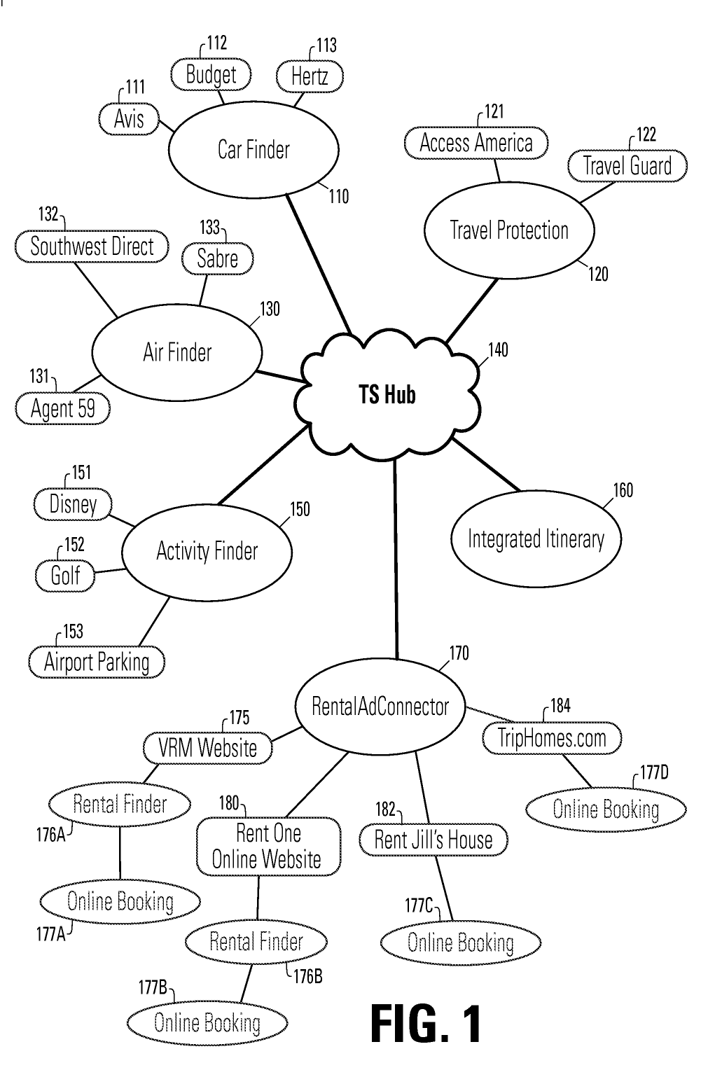

FIG. 1 illustrates a software and database architecture centered around a travel services (“TS”) hub server 140. In alternative embodiments, the TS Hub may support a VRM facing presentation or a traveler facing presentation. For VRMs, there are a variety of options for integrating TS functionality with existing web sites and backend software, including IFrames, Web Services and the so-called content conveyor, which are described in further detail, below. For travelers, it is a virtual travel agent. Integration technologies support access to TS Hub functionality from any participating website including Rent One Online's public site 180, various VRM websites 175, location specific websites 182, or any other site 184 that supports online booking of travel packages. The traveler will be able to purchase online or by phone. Similar capabilities will be available for the traveler or the VRM employee booking the traveler on the phone. Regardless of the source of the data, it will be included in the same vacation rental itinerary available to the traveler and VRM.

The TS Hub 140 provides a site for a user to login, create and view an integrated vacation rental itinerary. If a vacation rental booking is processed over the phone, by someone in a real estate office, for instance, a login will automatically be generated and e-mailed to the traveler for online access. Either a user or a represented user, through the user's representative will be able to purchase pieces of a vacation package 177A-D directly from this login and have them automatically added to their itinerary. Quotes for additional services will be offered to the traveler upon logging into the system.

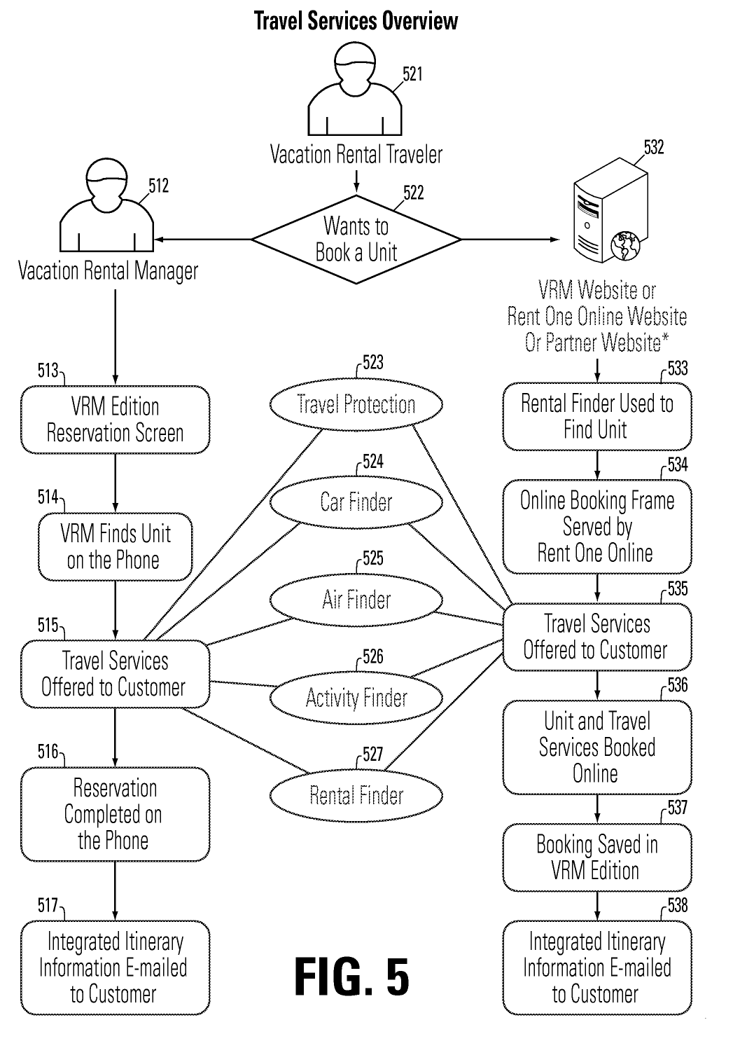

The rental finder 176A, 176B is responsible for handing the publication, search and booking of vacation rental units. It is designed to be separately included in VRM websites 175 without the TS Hub component. As a standalone component it can be used to query inventory for a particular VRM and return units matching various criteria. These units would then support the inquiry, quote & hold and online booking mechanisms present in the VRM and personal VRM (PVRM) embodiments of software, as will be further illustrated by FIG. 5. In general, the PVRM version is intended for an owner-manager who does not hire an agency to manage her property along with others' properties.

Alternative embodiments of an air finder component 130 may include connecting to one or more global distribution system operators (GDSs), offering discount tickets from others (e.g., Orbitz, Expedia or Travelocity), purchasing discount tickets in bulk and offering them via the TS Hub, and combining legs of trips from different providers 131, 132, 133.

A car finder component 110 can be implemented either be done through a GDS or by contracting directly with different car rental agents 111, 112, 113. Quotes may be presented side by side to the traveler or VRM when appropriate, for their selection.

A travel protection component 120 can be plugged into the appropriate point in the reservation process. More than one source of travel protection 121, 122 can be supported. Travel protection may cover the lodging portion of a trip and may extend to air tickets, rental cars, etc. Appropriate disclaimers and legal language will be provided for direct sales to travelers. Again, quotes may be presented side by side to the traveler or VRM when appropriate, for their selection.

An activity finder module 150 could connect to activities bookable in GDSs, to industry specific booking services (e.g., tee times), direct to the activity provider 151, 152, 153 or even manually booked by the VRM on behalf of the traveler.

A travel services client will also be developed. This client will contain all of the rendering code for the XML and will be able to be included on VRM websites as an IFrame. Alternatively, an HTML to ASPX conversion engine can be used to integrate rental finder 176A and online booking 177A with existing VRM websites 175, which adds features and webpage characteristics that are supported by code behind pages.

Travel Services may maintain one database that stores units from all available sources and accessible through all embodiments of the software, such as VRM edition, PVRM edition, and others. Units can be assigned a new UNIT_ID on publication to travel services, as their original, VRM assigned UNIT_ID may not be unique in a larger context. In this disclosure, UNIT_ID refer to the new UNIT_ID created for travel services. The unit table may maintain four KKPRODUCT_INFO fields, used consistently to provide a reference back to the originating product, database, table and id.

The TS Hub architecture supports purchase of vacation rentals and other travel services online in a single transaction. The traveler will typically find their vacation rental first and then build their vacation around their vacation rental choice. The data used to purchase the vacation rental can automatically be used to generate quotes for car rental, airfare purchase and travel protection. This technology will be integrated into the vacation rental management company's website 175, the Rent One Online website 180 and other partner sites 182, 184.

VRM user representatives will be able to add information to the integrated vacation rental itinerary such as door codes, check-in procedures and other information useful to the traveler. If the traveler chooses to allow it, the VRM will be able to view other parts of the itinerary not booked directly through them.

Vacation rentals may be offered as part of a package tailored by the VRM to meet the needs of their customers. A VRM in Orlando may choose to package a rental car and Disney tickets while one in Aspen may create packages for each major ski resort.

Some or all of the services offered for sale along with vacation rentals may be priced by the VRM agents themselves. Using a profit sharing structure, this system will allow the individual VRM agents to price individual components such as rental cars. This will allow the VRM agents who best know their markets and clientele to maximize their profits along with those of the system operator.

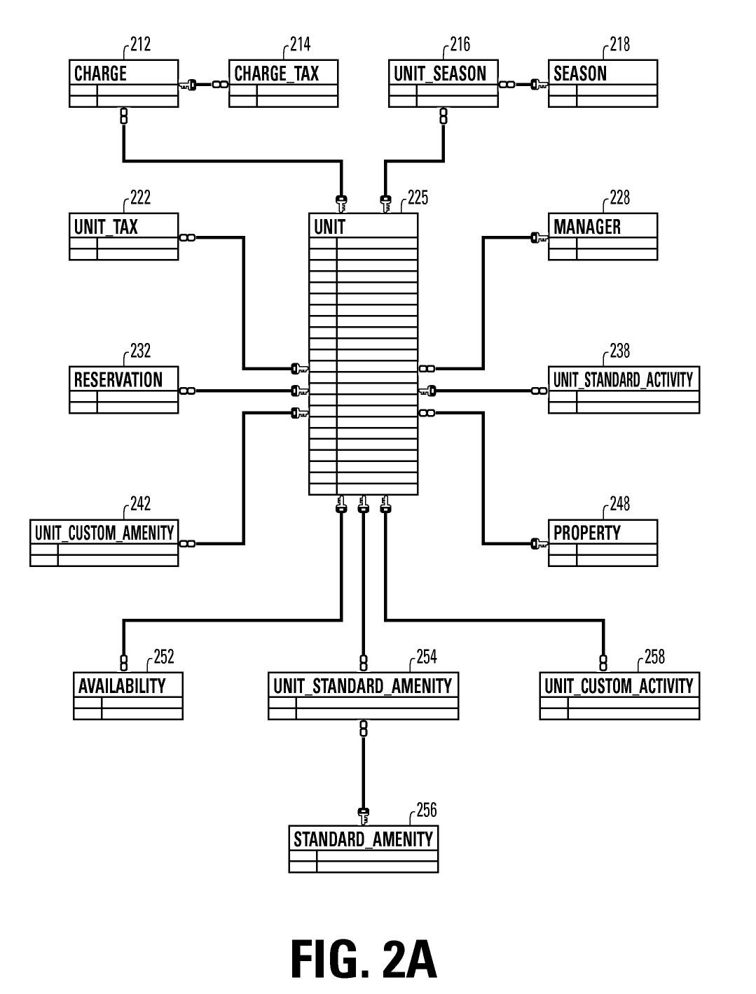

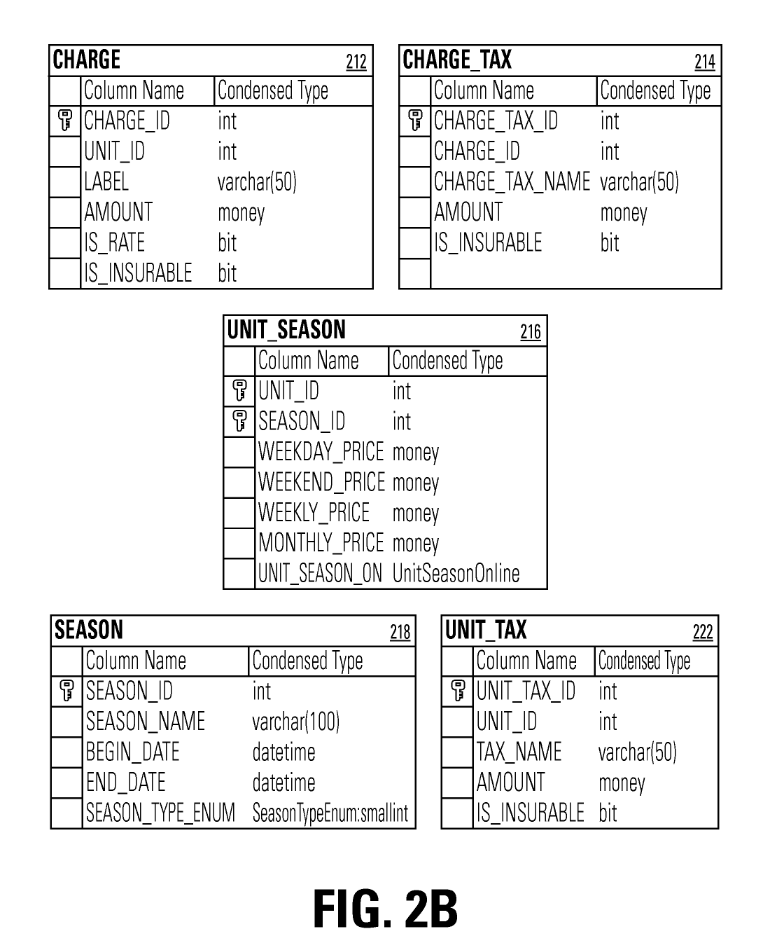

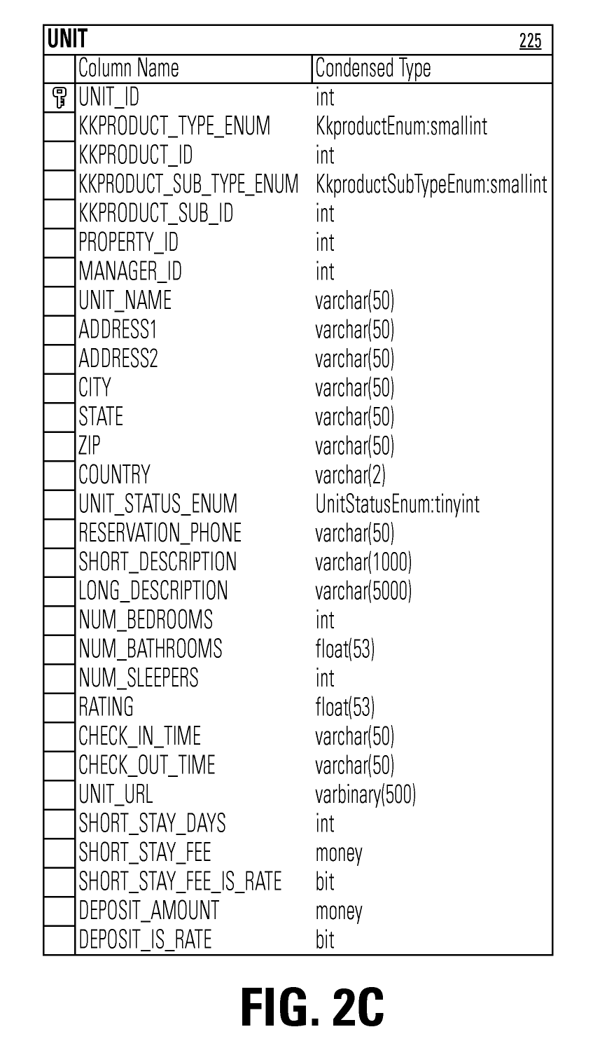

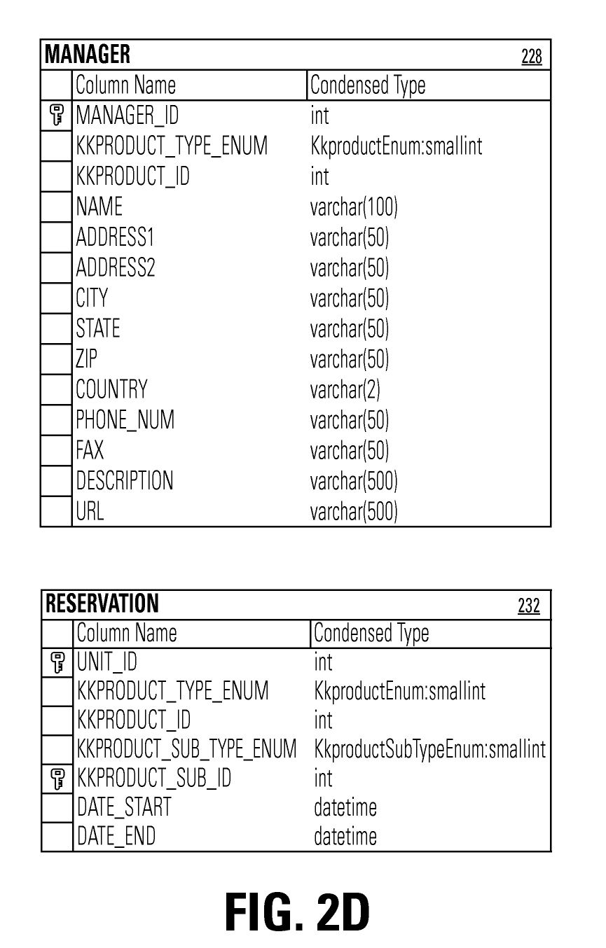

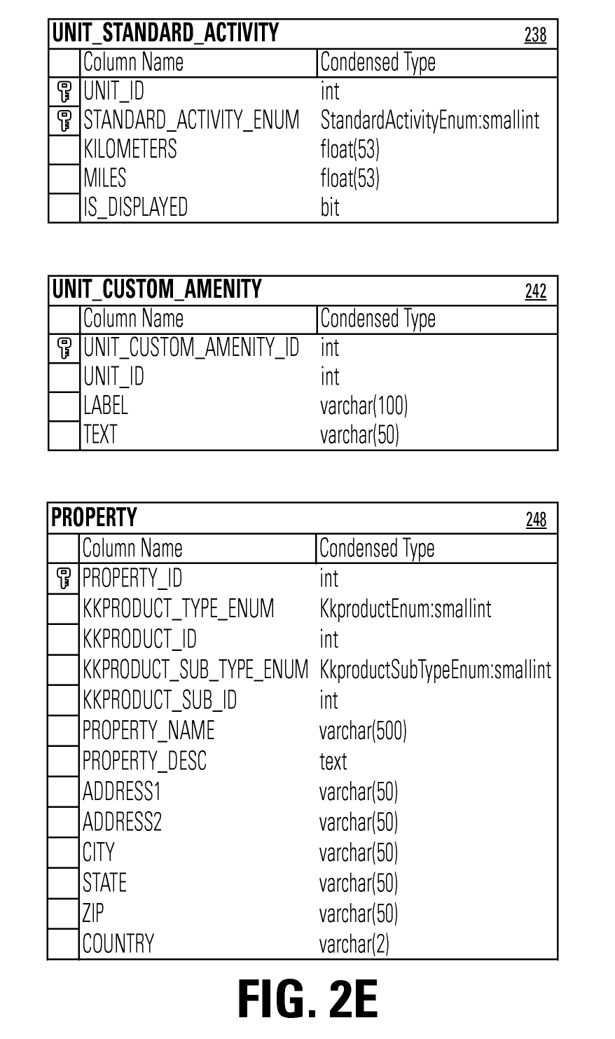

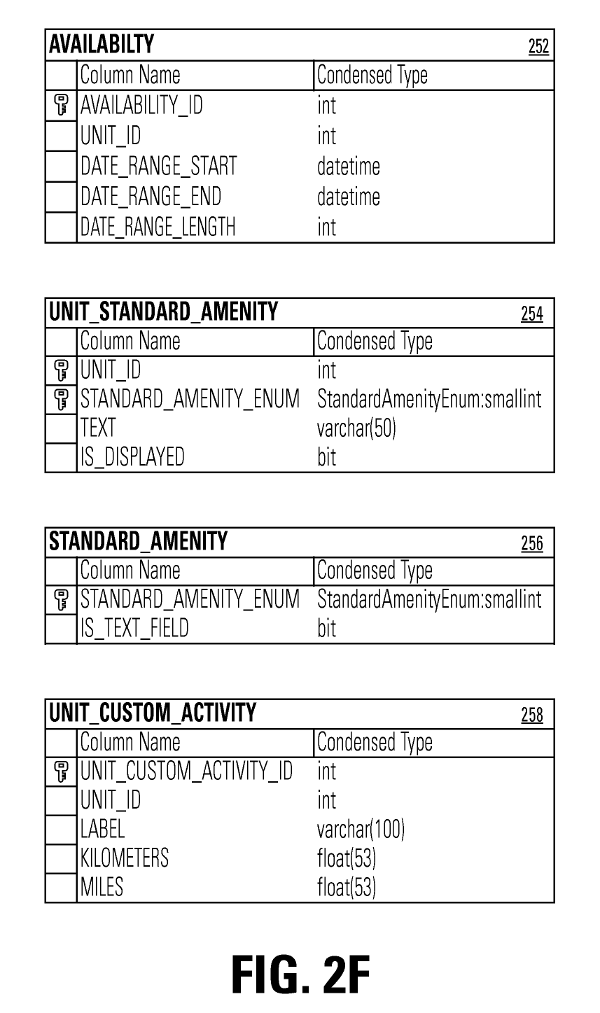

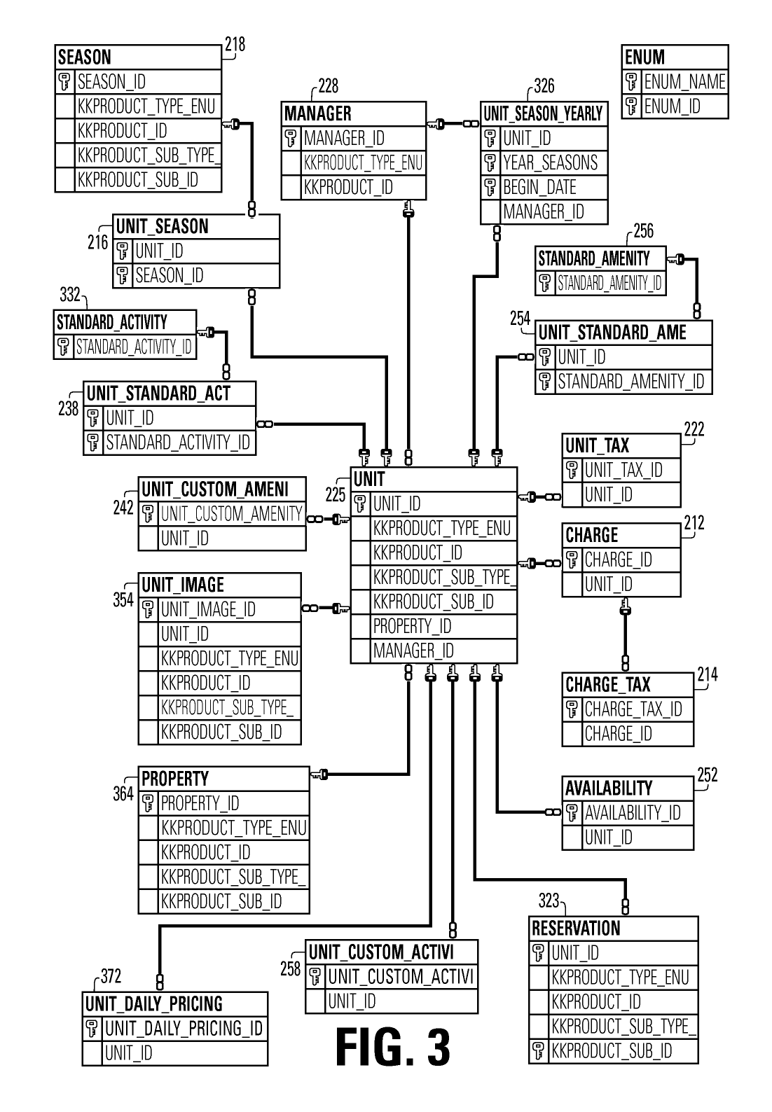

FIGS. 2-3 depict alternative database structures for maintaining unit inventory information. Numbering is parallel in these figures, as FIG. 3 adds just a few tables. The central table is the unit table 225, which represents inventory that can be offered. Some fields of the unit table link back to the original inventory source. Others, generally depicted in FIGS. 2B-F, include property ID, manager ID, unit name, address, unit status, phone number for reservations, long and short descriptions, number of bedrooms, bathrooms and sleepers, quality rating, check-in and checkout times, a URL for further information regarding unit and other related to the particular unit. The unit-season table 216, linked to the unit table 225, lists standard prices for weekday, weekend, weekly and monthly use of the unit. The season table 218, linked to the unit-season table 216, defines particular seasons to which different prices may apply. The charge table 212 in a related charge-tax table 214 covers fees charged with the rental, such as cleaning fees and the like. It can be used to store instance fees that are charged once per rental, instead of on a periodic basis. The unit amenity 254 and custom amenity 242 tables cover features such as hot tubs, indoor parking, and view. Standard amenities 256 are enumerated for consistency. The custom amenity table permits managers to add features that are not standard in the amenity enumeration 256. The property table 248 provides a way of grouping units. The reservation 232 and availability 252 tables provide alternate ways of keeping track of when the unit is committed. One table of the other will be given precedence. Typically, the availability 252 table will have precedence and changes to the reservation 232 table will be updated to the availability table. The unit tax table 222, linked to the unit table 225, identifies the taxes that may be applied to the particular unit. The manager table 228 identifies the VRM that is managing the unit. The standard activity 238 hand custom activity 258 tables identify local activities that the VRM user's agent will want to have in mind when working with the user to package a vacation. He's useful to have an approximate distance from the unit 225 to the activity, to assist in the marketing of the activity. In figure three, the added tables are unit-season-yearly 326, unit image 354 and generalized enumeration 365. The unit-season-yearly table coupled to the manager and unit tables stores data for optimized price calculations in searches. The unit image table links a unit to pictures. The generalized enumeration table supports enumeration across the other tables. One enumeration table can support enumeration of many attributes, with some effort to assure uniqueness of enumeration types across tables.

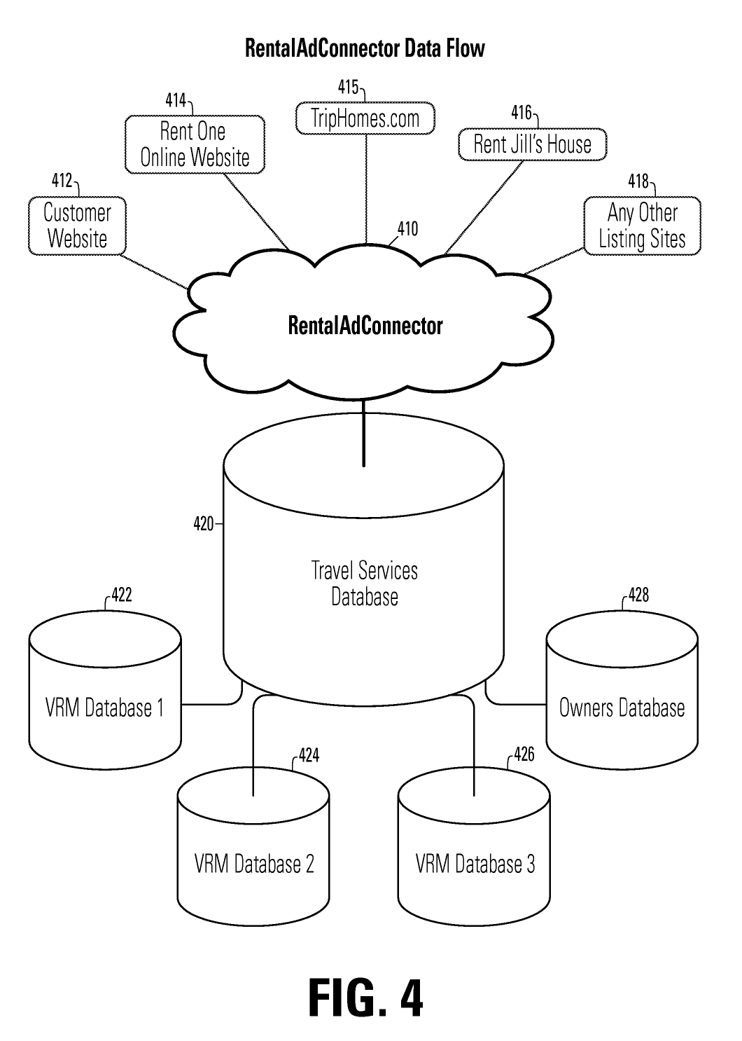

FIG. 4 is a high-level block diagram of the rental ad connector 170. Features repeated from FIG. 1 include a various websites 175, 180, 182, 184. The travel services database, mention above is depicted with reference 420. One or more VRM databases 422, 424, 426 may be coupled to and synchronized with the travel services database 420. One or more owners databases 428 associated with private VRMs can be similarly connected to or synchronized with the travel services database.

The RentalAdConnector 170 is tasked with marshalling data to and from advertising partner sites. This allows a VRM to advertise their properties on various sites and portals and receive bookings from travelers through those sites or portals. Bookings made at different sites will be supported by and automatically entered into the VRM software, tracking the origin of the reservation and whether it is canceled or fulfilled.

The RentalAdConnector engine 170 manages the relationship between the VRM software 140, in FIG. 1, and multiple sources including advertising partner sites 184, the VRM's website(s) and 175, 182, the Rent One Online website 180 and others 418. Unit information, availability, pricing and other information is automatically published from the various VRM product databases 422, 424, 426 (of which there may be one instance per VRM). Bookings and inquiry requests are taken from each of these sites and fed back into the VRM software automatically.

Updateable Integrated Itinerary Data Structure and System

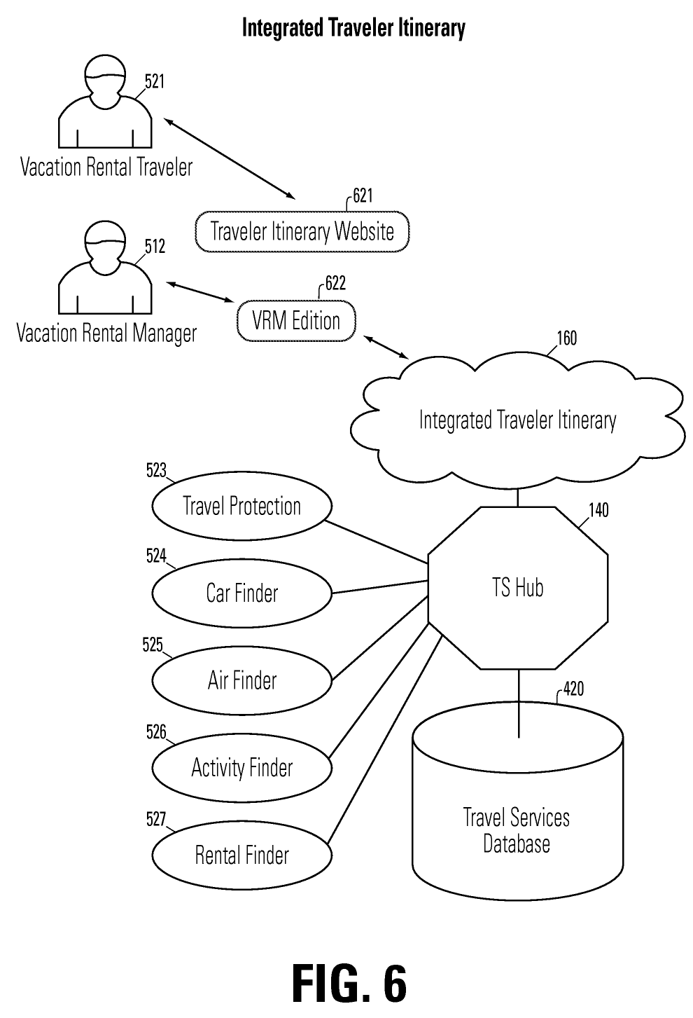

FIG. 6 further illustrates the role of an updatable integrated itinerary 160. This technology can provide source-agnostic travel services. Whether the booking happens directly on the phone with the VRM, through the VRM's website or through an advertiser partner website, an integrated itinerary will be generated for the traveler. Depending on the source of the booking, cancellation and modification policies may vary. The traveler will also have the option of adding additional Travel Services to their vacation rental package either through the VRM or by accessing their personal integrated itinerary. Things like package upgrades may be available even if the vacation rental was not purchased directly through the VRM.

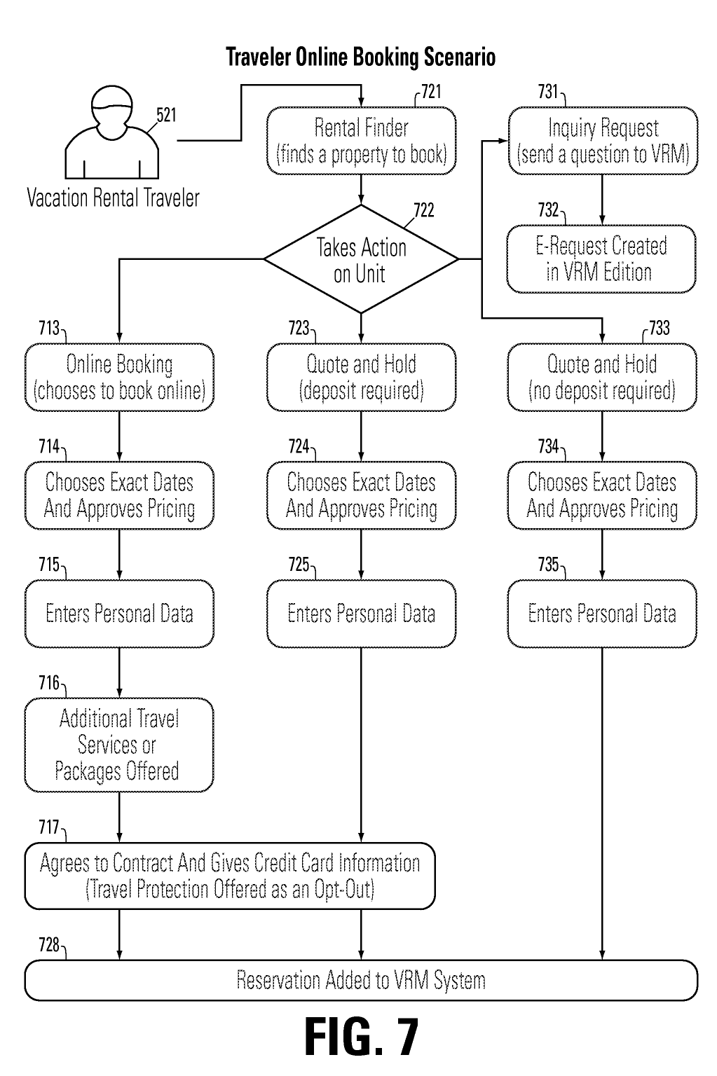

FIG. 5 provides further detail of the alternative interactions between a user or a vacation rental traveler 521 or a user's agent or representative 512 in the process of booking a unit 522. The core travel service components are as depicted in FIG. 1: travel protection 120, car finder 110, air finder 130, activity finder 150 and rental finder 170. In the left-hand column, and the user is working through a users agent or representative 512. The agent accesses a reservation screen 513 and makes a query to find the desired unit 514 while the user is on the telephone. The VRM offers the unit and, potentially, additional travel services to the customer during the phone call 515. Typically, the reservation is completed while the user is still on the phone 516 (though, FIG. 7 illustrates quote and hold alternatives, with and without deposits.) When a reservation is completed on the phone, the system automatically generates an updatable integrated itinerary and e-mails a link to the customer 517. Alternatively, the user 521 may access a VRM website, a portal website or partner website 532. The rental finder component 176 is used to find the desired unit. The TS Hub 140 provides support for online booking 534. Travel services in addition to booking the unit 535 are offered to the customer. The unit and travel services may be booked directly online to 536. The booking is persisted 537 through the TS Hub 140. Upon completion of booking, a link to an updatable integrated itinerary is e-mailed to the customer 538.

For regulatory compliance and licensing purposes, it is useful to structure the system architecture and interaction protocols so that servers are sold by the system operator, leaving the VRMs to market travel services, rather than selling the services. As a marketeer, the VRM does not need to be a licensed insurance agent or travel agent. All transactions can be arranged to occur in the state of California or another chosen jurisdiction, to assure that consistent legal standards and regulations apply.

System Connectors to Independent Inventory Sources

The integrated architecture can support multiple suppliers or vendors of each type of travel service simultaneously. For instance, Avis 111, Hertz 113 and Budget 112 rent-a-cars all may be available. The choice of provider(s) may be a VRM system-wide choice or a more granular per reservation choice, depending on the system implementation.

The system can handle all reporting from the travel service provider(s) and provide a summary report and detail report to the VRM monthly or on another chosen schedule. The VRM may earn a marketing fee for various services sold to the traveler through the system. One report will be delivered to the VRM containing a summary of each provider's sales to their travelers and associated marketing payments. This report may be part of an overall periodic bill, for instance, a monthly bill. The periodic bill lists a fee, such as $1/mo/unit, for participation in the system and may be delivered with a check payable to the subscriber, when the marketing fee payments for traveler purchases the VRM subscription fees. The system can be configured to report on a reservation posting basis, as most online systems currently operate (which results in non-cancellable reservation restrictions, so that commissions refunds need not be sought) or to report on a reservation fulfillment basis, taking into account no shows, early departures and extensions of reservations.

Some technical implementation details are worth mentioning. Services can be customized for the traveler to the extent practical, given the traveler-related information already entered in the process of booking a vacation rental. For instance, choices offered may be customized to the age of the travelers (adults vs. children or more granular, if information is available) and to the vicinity of the rental unit. In one embodiment, user interaction can be accelerated by collecting quotes for services in the background and adding information collected added to the inventory page using AJAX (asynchronous JavaScript and XML). As the performance of inventory sources improves, background and anticipatory caching will become less significant.

Information will only be entered once by the VRM or traveler. As additional information is entered about the traveler, this may result in changes to the quotes previously obtained. This processing also can proceed in the background, preferably with alerts to the person making the booking.

The system will automatically bundle the traveler information along with specific service parameters and pass them directly to the service partner. It will store selected configuration options for the service on system servers. Confirmation of purchases will be transmitted back to the system (either synchronously or asynchronously) and stored on the system servers.

The integrated itinerary benefits travelers, whether a vacation rental is booked online by the traveler or on the phone with the VRM. In both embodiments, the itinerary is available online to the traveler. This itinerary is updatable by both the traveler and the VRM. It supports sales in separate sessions and integration of other pieces into a vacation rental package.

Updating of an itinerary will be supported. Where allowed by the service partner or other provider, modifications of services will be done real-time. All modifications will be logged and new confirmation numbers stored in the system databases

Fully integrated travel protection can be supported by this architecture. Travel protection can be seamlessly integrated into the reservation process: When a unit or package price is quoted, a travel protection quote can be generated and automatically added into the total cost of the reservation. This quote can be updated continuously as items and activities are added to the interactive itinerary. A configuration checkbox allows toggling of whether the travel protection quote is included in the total price of the reservation. Once the traveler's state is entered, the travel protection quote will be updated for any policy types not licensed in their state of residence. If a VRM manages or owns units in multiple states, the travel protection quote will be updated to resolve any problems with licensing restrictions by location of unit. Upon receiving back a signed contract from the traveler, the VRM will indicate whether the traveler wishes to purchase travel protection. The charge for travel protection will appear as a separate charge from the travel protection provider. Any failure to process a credit card may be handled directly by the travel protection provider or through the system operator.

At this juncture, we review the design capabilities supported by this architecture. Later, we will return to implementation details.

One design capability is fully integrated car rental sales. A variety of integration modes may be practical. For a VRM-facing embodiment, as part of the setup, the VRM will select nearby airports which they wish to get quotes for (for example, there are three airports a traveler in DC may fly into). If acceleration by pre-caching is desired, when the dates of travel are chosen, a background process will begin requesting quotes from car rental providers. These quotes may be either displayed as individual prices or as part of dynamically created packages. If the traveler wishes to fly into a different airport, the VRM can enter the airport code appropriate and receive rental pricing for that airport.

A comparative shopping engine will display the prices for different car rental providers for the VRM to compare. There also may be system-offered special, in addition to connecting travelers with well-known brands. Those price quotes will be fully integrated into the display of pricing options.

For VRMs, initial site set-up and integration setting can determine whether the user's agent is encouraged by the software offer rental cars with each purchase, or only to offer it as part of a package.

Another design capability is fully integrated airfare sales. Again, if pre-caching is desired, as soon as the VRM is given the zip code of the traveler (and, optionally, knows the unit they will be staying in) airfare rates and routes can begin to be calculated in the background. The airfares will be displayed in the form of “starting at” prices. Prices will be available for each combination of nearby airports as well as number of hops. The VRM will also be able to enter additional information to further refine the choices such as times of travel, preferred airports, etc.

Fully integrated activities that are geographically convenient to the rental location can be offered. Activities may include golf tee times, tours, cruises, airport parking, theater tickets, amusement park tickets, parasailing or just about any other activity valuable to the traveler which the VRM feels that they can market. Activities may be added on a system-wide basis through partnerships with activity partners. Or, activities may be added directly by the VRM (“Beyond the Reservation”). Activities added by the VRM can involve local businesses with whom the VRM will contract directly. Printed activity books or listings may also be available so that the traveler can book additional activities through the VRM once they arrive or bring a coupon to the activity provider which will eventually yield payment to the VRM. Activities may be either available as separate additions to the reservation or as part of a package. Relevant activities can be identified to the user or user's agent once the number of adults and children are entered. The activities offered can be targeted to the actual travelers—if they're all adults, then the system need not list tickets to activities targeted at children. The VRM will be able to configure which activities they choose to generate prices for in the application.

A configurator model of vacation assembly can be implemented to allow the VRM or traveler to pick and choose among multiple parts of a vacation (with the vacation rental being required). The traveler/VRM will be able to choose among car rental, airfare and various activities they would like to add to their vacation. The cost of the vacation will be the total of all the parts.

Dynamic Grouping of Package Elements

A dynamically created vacation rental package is tailored to the needs of a particular user. This can be done dynamically online, either by the traveler or within the VRM software system. Packages may be created based upon the dates of travel, number of adults/children in the party, origin of travel, unit occupied or other relevant data. Package elements such as a rental car will be automatically booked for the correct length of stay.

Dynamic package offerings present significant opportunities for initial selling and later upgrading. In a simple case, from either the VRM application or the VRM's website with integrated capabilities, a traveler may be offered a package customized for their needs. Unlike most packages, the system need not be limited by fixed definitions of the place the air travel originates, the number of days for a car rental, or the number of tickets for an activity.

Dynamic packages allow the VRM to define certain types of packages they would like to offer which will be priced according to the needs of the traveler. Packages including airfare will have that airfare originate from the proper city and have the appropriate number of adults and children. Packages including car rental will be for the correct number of days in the vacation. Packages including activities will be targeted appropriate for the travelers (number of adults/children, etc). Packages may be priced as either a total price for the vacation or as a per person cost.

When a VRM is marketing a dynamic package, upgrade options can be offered. If a traveler opts not to purchase a package, then that package may remain available for later upgrade which would allow the traveler just to pay the difference and reap the savings of the package deal. The VRM will be able to configure how long this upgrade option will be available.

In either a dynamic package or as part of an integrated itinerary, the VRM may allow some parts of the package to be chosen by the traveler. For instance, they may offer packages starting at $159 per person including vacation rental, car rental and lift tickets—the traveler may be given the option to choose their favorite ski resort changing the pricing of the package. The traveler may also be able to add onto a package either at standard configurator pricing or at a discount for all additions.

Pricing of package elements by a VRM is unique in the vacation rental segment. A variety of structures are possible. For instance, in an affiliate program, the affiliate may be paid a fixed fee or rate on each sale. On a tour pricing model, the affiliate would receive a dynamically created package at a set price and mark it up from that base price. Offering a package base price and splitting profits generated is not a model currently used in the industry or supported by any commercially available software package.

This technology enables VRMs using the VRM application to control pricing and commissions that depend on pricing, with a display of pricing and commission information that allows the VRM user agent/representative to understand the impact of their pricing decisions. In some cases, such as rental cars, where it is useful to allow the VRM to control the sale price, as they have the best understanding of what their local market and travelers will bear. In the case of rental cars, the system will provide the VRM a fixed discount pricing and then allow them to choose their markup as they wish. Alternatively, in an environment where the VRM's marketing payment is proportional to the profit earned by the system operator, the VRM has an incentive to achieve the maximum profit while still staying within local market limitations. For packages offered by others at a fixed price, as opposed to dynamically created packages, this may not be an option for the VRM.

One benefit of this travel services model is that it will be able dynamically to generate prices for trips. In the case of exact dates, this will be an exact cost for the stay. Optionally, the amount displayed in the search results includes charges and taxes. In the case of flexible dates, if the total price cannot be calculated exactly (i.e., multiple available time spans meet criteria but have different costs), a “Starting at” price will be displayed.

For units, pricing information would be displayed on the unit description page. It would list the pricing for the various seasons available. This is important to users who utilize the flexible availability search, so they can see the actual pricing. Pricing information will be modeled after the pricing structure implemented. The concept of seasons will have to be expanded to include an option to specify the types of booking allowed (inquiry, quote & hold, or online booking) and how far in the future to allow booking. Inquiry forms will be available for various times and seasons.

Integrated Itinerary Data Structure and System (cont.)

FIG. 6, again, is a high level depiction of an integrated itinerary 160, which will be created for every traveler booking a vacation rental in the system (and may be automatically e-mailed to the traveler 521 upon completion of a booking). The itinerary will include all parts of the vacation 523-527, accessible through the TS Hub 140 and persisted in a travel services database 420. It may include helpful details (for instance, directions for obtaining Disney tickets from the will call box). That itinerary will be available from the system operator's itinerary website 621 or, alternatively, through an integrated package used by the VRM 622. The itinerary will be accessible to both the traveler 521 and the VRM 512 (depending on access permissions to be set either by the traveler, the system operator or the VRM.) The itinerary will be printable so that the VRM may include it in the traveler's rental so they have it upon arrival.

The integrated itinerary technology allows travel services purchased from multiple avenues to be combined into one interactive itinerary accessible to the traveler on the web and which may be printed by the VRM for delivery to the traveler. The traveler will be able to add additional components to their vacation itinerary. The manager will be able to add additional information to the itinerary as well. The itinerary will remain a living document and may be altered at any time within the limitations of the business rules set for each travel services offering. At any time, the traveler will be able to log into the integrated itinerary and purchase additional parts of the vacation. Travelers may also be able to upgrade their vacation rental reservation to a full package. The VRM will also be able to login and see at least their section and add additional information to it for the traveler (location of unit, key codes, etc). Where allowed, the traveler will also be allowed to make changes to their vacation through this interface and they will be automatically reported to the VRM or partner travel services provider. Depending on security settings, the VRM may also be able to make changes to the itinerary and activities by request of the traveler. Traveler rerouting due to weather or catastrophic incidents may be possible.

FIG. 6, again, shows the basic parts of the Interactive Itinerary and how information flows within it. The process begins when the vacation rental is purchased along with any additional services. These all go into the TS Hub 140, which stores the information in the Travel Services database 420. The integrated itinerary 160 is generated from this information real time for the traveler 521 or VRM professional 512.

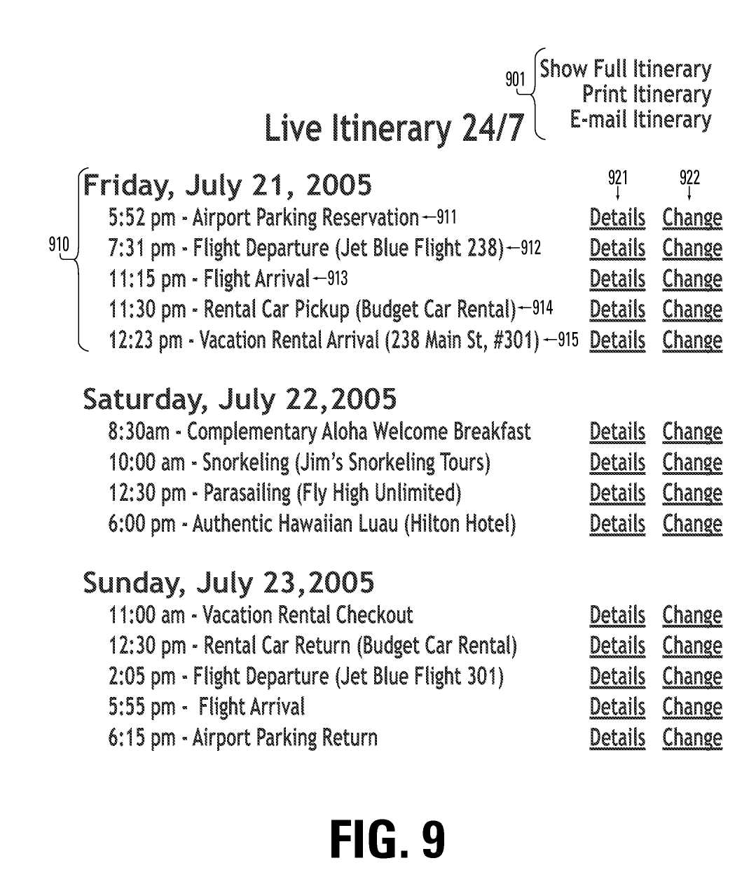

FIG. 9 is a content mock up of a chronologically organized integrated itinerary. One day in the itinerary 910 may include several items 911-915 assembled from independent sources. In this illustration, items are highly condensed and organized chronologically. Details of an item can be accessed by selecting the details control 921. Items can be changed, if supported by the item source, using the change control 922. General controls 901 are provided for expanding all items, printing or forwarding the integrated itinerary.

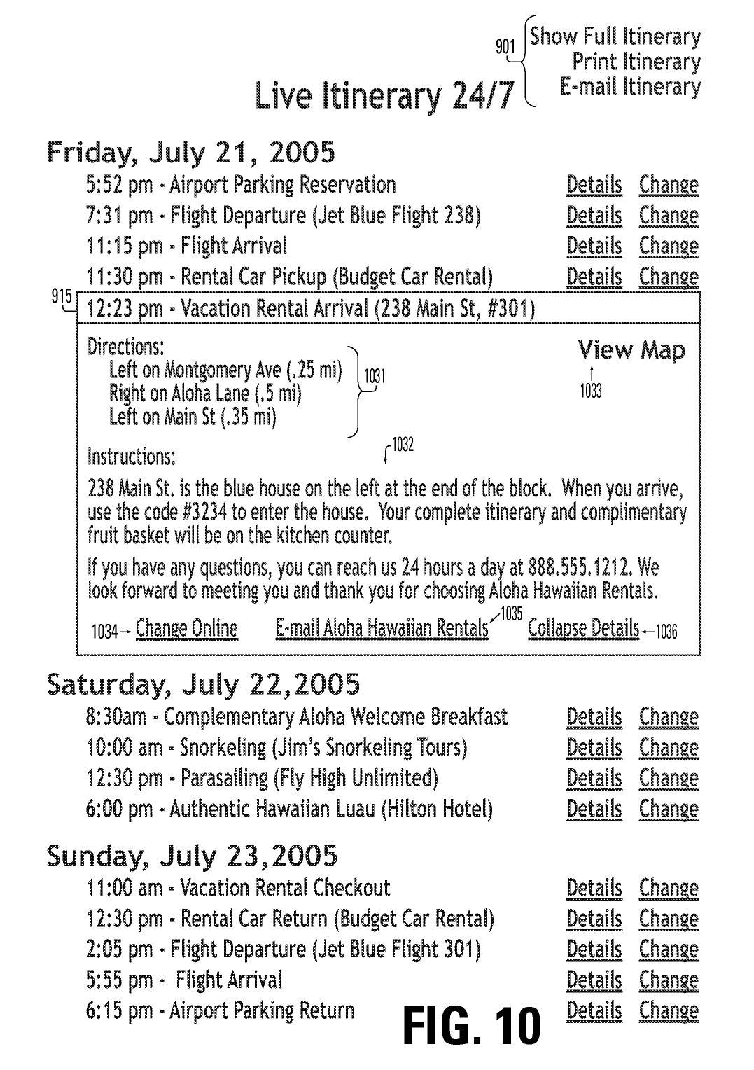

FIG. 10 shows details of possible information available 1031, 1032 for one of the items 915 on the itinerary. Clicking on the Details or Change 1034 links will display the information necessary for the requested operation. When location information is provided, a view map control 1033 may connect a user to a map, with or without travel directions. Other controls may send an e-mail to the VRM 1035 or collapse details of the item 1036. The information may be shown inline as depicted here or may link to another page.

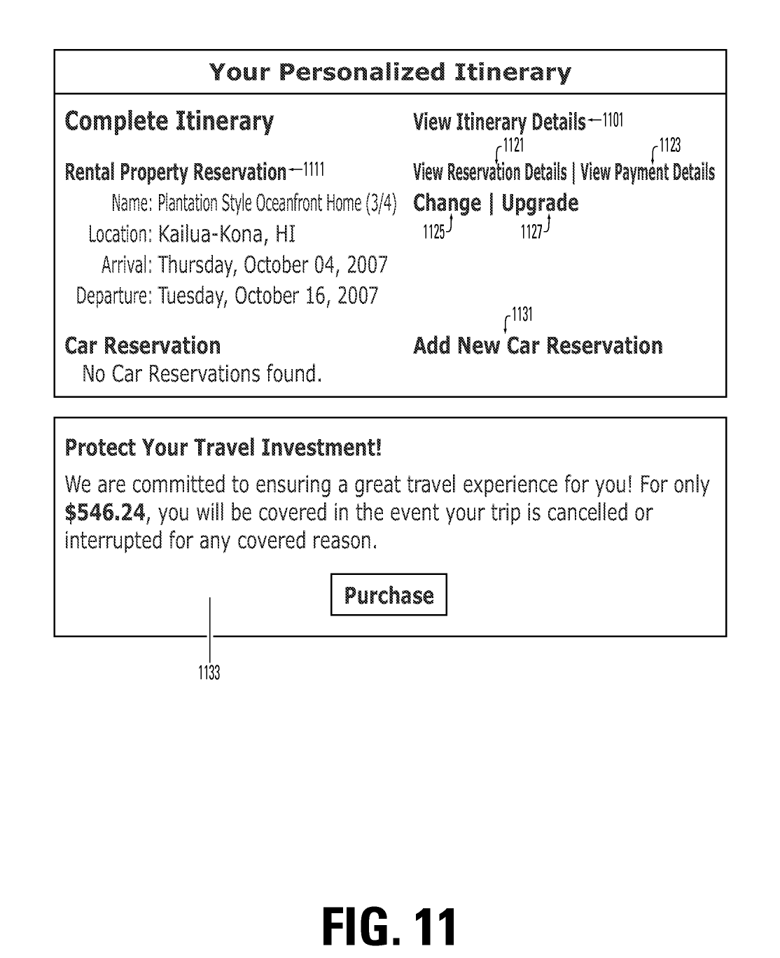

FIG. 11 is an alternate embodiment of the updatable integrated itinerary, after addition of just a first item 1111. To the extent applicable, this figure is numbered in parallel with FIG. 7. Controls are provided for viewing all details of the itinerary 1101, viewing details of a single item 1121, viewing payment details 1123, changing an item 1125 and upgrading an item 1127. In other embodiments, more details and multiple options may be displayed for upgrading an item 1127. One or more additional controls 1311 are provided for adding items. Also depicted is purchase of travel protection 1133. In this illustration, the travel protection is provided on an opt-in basis. As described, it might alternatively be offered on an opt-out basis.

Additional views of the itinerary will be provided. Some examples may be a printable booklet with one activity per page, a full detail itinerary suitable for printing, versions displaying different mapping options, and other additional views of the itinerary that prove to be useful to the traveler.

The itinerary information may be made available in a variety of formats. Included in these may be an interactive website which the traveler can access to view details of the itinerary, a printable version for the vacation rental manager to include with a welcome packet for the traveler, or a screen within the VRM software for the vacation rental manager to view the itinerary and assist the traveler with any required changes.

The integrated itinerary is very different from a paper itinerary in that it is constantly updated and provides an interface for the traveler or vacation rental manager to change, add to or remove items from the itinerary. The VRM will also have the ability to add additional information to their part of the itinerary. Such information may include the exact address of the unit, a door lock combination, check-in instructions or other information that they may wish to make available to the traveler after the initial contact.

Unlike most traditional itineraries, a lot of intelligent mapping and directions are possible with the integrated itinerary 1033. For instance, if the first stop after arriving is the car rental agency, followed by check-in at the vacation rental manager's office and then arrival at their vacation rental, the directions should be based on the logical start point and destination. Because the location of the vacation rental unit is known, directions for activities such as parasailing should originate from the address of the vacation rental unit. This functionality should not preclude the traveler from choosing alternate start and end points.

Data Search Capabilities

Functionally, many types of searches will be supported. The availability search will be able to take either exact or flexible dates as input. The exact date search will allow the user to request that units which are partially available during those days be returned (this is a requirement from the VRMs). The flexible date search will look for units which have X days of availability between two given dates with an option of specifying the day of the week to begin travel. For example, you could specify you want a unit which is available for a three day weekend next summer.

A table named AVAILABILITY 252 will be responsible for maintaining all availability data. This table can be seen in FIGS. 2-3, which depict high level variations on a database that supports rental of units. There is also a RESERVATION table 232, which supports reference and integrity checks. Fields in the RESERVATION table provide reference back to tables in other systems which generated reservations, fields that are named in FIGS. 2B-F with a “KK” prefix. The Rental Finder component is not directly responsible for handling reservations but instead directs traffic to the appropriate web service to handle online booking. Changes to reservations will be handled by first deleting the existing reservation and then publishing the new reservation.

Searching also is supported based upon price, using the UNIT_SEASON_YEARLY table 326, which is optimized for searches. The UNIT_SEASON table 216 includes pricing information. A field named ONLINE_BOOKING may be an enumeration with the following values: InquiryRequest, QuoteAndHold, QuoteAndHoldWithDeposit, and BookItNow. This table can be decoded with reference to a SEASON table 218 that gives beginning and ending dates for seasons defined by the unit's manager. Manager related information is kept in the MANAGER table 228. Readily searchable information can be maintained in a UNIT_SEASON_YEARLY table 326. Alternatively, a UNIT_DAILY_PRICING table 372 can provide pricing information. In this alternative embodiment, one can quickly calculate the price for a unit for a set of dates from stored prices for every day of the year for a number of years into the future. For searches that return multiple possible prices (i.e., where flexible availability is specified and date range spans multiple seasons), fuzzy logic can be used to show those that most closely match the desired price range.

One appealing feature is the ability to search by unit type (home, condo, townhouse, duplex, etc.). The UNIT table 225 may contain this information. In the UNIT table, a field named TS_STATUS may be used to enumerate whether the unit is published (meaning that the unit is available for searching and online booking), unpublished, or in an error condition that needs to be checked manually.

Several embodiments of a location search can be used. The first embodiment will use a drilldown system. In other embodiments, textual location searches and circle-based searching will be supported. For international locations, this will require map locator services particular to the country or region. For US locations, it can be supported with an inexpensive zip code database. For even better accuracy, geocoding can be used to find the unit's latitude and longitude from its address, and location-based searches can be performed using these coordinates.

An amenity search is can be supported by a series of logically grouped checkboxes to indicate which amenities are desired. A base list can be established or vacation rentals using the UNIT_STANDARD AMENITY 254 and STANDARD_AMENITY 256 tables. VRMs and owners can be allowed to configure their own amenity list, supported by a UNIT_CUSTOM_AMENITY table 242.

Activity searches are useful, given the strong relationship between vacation rentals and destination based vacations. Activities would include things like hiking, scuba, amusement parks, etc. Activities can be marked by the VRM with their distance from that unit, either calculated and entered in the database or geo-coded and calculated as a difference in locations. System standard and unit/property custom activities can be supported by tables UNIT_STANDARD_ACTIVITY 238 and UNIT_CUSTOM_ACTIVITY 258, respectively.

Travelers who have a preference for a particular VRM or unit owner may search by property manager or owner, using the MANAGER 228 table.

The tables in FIGS. 2-3 further may include UNIT_TAX 222 information. They may include PROPERTY 248 information that links several units to an overall property description, optionally across VRMs that all have units within the same resort destination. An enumeration table ENUM 365 can be used to expand compressed ENUM_ID codes using ENUM_NAME text. Multiple images of the unit can be maintained in or linked to through a UNIT_IMAGE table 354.

Integration of Independent Inventory Sources with Itinerary Data

Car Finder

Car finder is an internal name for functionality designed to allow travelers to purchase car rental through both the VRM software package as well as from websites owned by VRMs or others.

Car Finder will be architected such that multiple vendors and transmission protocols will be supported. A proprietary protocol will be developed to support purchases both from the VRM software as well as websites served by Travel Services. This protocol will consist of a group of web service methods and XML data structures which will communicate only the relevant data to purchase a car rental.

Once the car rental information reaches Travel Services through this proprietary architecture, it can be used to obtain quotes simultaneously from multiple vendors as well as purchase car rentals. One embodiment will be based on the Open Travel Alliance (OTA) specification. Adapters will be built for any car rental agencies which use variations of the OTA spec. For car rental agencies which use proprietary transmission protocols, those protocols can be supported in parallel with the OTA specification. A second embodiment uses a web services interface.

Information transmitted and received will be stored in the Travel Services database 420. Price quotes may be kept is a separate table or integrated into the TS database. This information will be later available for producing an integrated travel itinerary as well as making changes to existing reservations.

The comparative shopping engine will be able to display rate quotes from other major websites alongside quotes generated by the system operator and its partners. The comparative price quotes will generated based upon a per day charge for vehicles from the same company. They will generally be generated in real time, although they may be cached by the system operator's servers to enhance application performance.

In some embodiments, the car rental quote process will begin as soon as the dates of travel are entered into the VRM software package or a unit and days of travel are selected on a Travel Services enabled website. This processing will occur in the background allowing the quotes to be instantly available when the traveler or vacation rental management employee is ready to review them.

As additional information is provided, these quotes will be refined accordingly. For example, if airline tickets are purchased, only the car rental locations for that airport will be displayed. Prior to this, multiple locations in the area may be displayed to the traveler or vacation rental management employee.

Air Finder

The air finder component will enable the traveler or VRM professional to search for appropriate airfare to deliver the traveler to their vacation rental property of choice. The general functionality will approximate that of most online travel agency interfaces. It will allow for multi-segment, multi-provider air ticketing. Multiple options will be available to the traveler and searches will be able to be refined to provide the optimal listings for the travel required.

The options for air travel need not be limited to the standard offerings of any one Global Distribution System (GDS). The options may originate from a variety of sources including multiple GDS systems, discount fare offerings and consolidators, last minute fare search engines, direct links to various airlines or any other technologies which offer a better variety of travel options.

A proprietary communications protocol consisting of web service methods and XML structures can be used to transfer quote requests and purchasing options between the VRM software or Travel Services enabled website and the Air Finder hub. The hub will be responsible for distributing the request to the appropriate air travel partner(s). In the case of obtaining quotes and refining searches, these will be distributed to any travel partners in parallel and the results will be correlated by the system operator's servers.

The initial protocol development at this time remains undecided. As practical, the Open Travel Alliance (OTA) specifications can be used to provide the greatest flexibility in communicating with present and future airfare providers. Any vendor specific modifications of the OTA specification will be handled by adapter technology built on the standard OTA specification. Other proprietary protocols will be supported in parallel to the OTA specification.

One of the largest frustrations of searching for airline tickets online can be waiting for the initial price quote as well as all subsequent refinements. The servers in this system can begin preparing the airline travel options as soon as the city of origin and destination are known. In the VRM software, this will be done as soon as a zip code is entered for the traveler's residence (as the destination will already be known at that point). The search can be conducted on any appropriate airfare partners simultaneously.

When possible, the Rent One Online servers may submit quote requests under a variety of parameters which are thought to be desirable to the traveler. For instance, if a traveler is located in the District of Columbia, all three nearby airports (DCA, BWI and Dulles) may be searched in parallel. The results will be cached on the Rent One Online servers and where possible used to eliminate the normal delay of submitting additional searches to our airline partners.

Activity Finder

The Activity Finder module will be responsible for providing price quotes and booking opportunities for a wide variety of services. Some potential examples may include airport parking, golf tee times, local activities, tours, cruises, daily excursions, and many other services desirable to travelers.

Some activities will be contracted by the system operator and made available to our vacation rental managers through our VRM software or Travel Services enabled websites. Other activities may be added to the offerings in the VRM edition or Travel Services websites by the VRM itself. For example, a vacation rental manager in Kona, Hi. may wish to offer volcano hikes through local providers as stand alone activities or as part of a package. These activities may remain the exclusive offering of the vacation rental manager or they may be shared among other vacation rental managers in the area.

Unlike airfare and car rental purchases, many activity purchases may not be consummated entirely online. In some cases, they will be quoted, purchased and confirmed online. In other cases, reservations may be made online with payment due to the activity provider directly at the time of the activity. In other cases, the actual reservation may be made by the vacation rental manager over the phone directly with the activity provider.

The actual fulfillment may also vary. In some cases it will consist of a confirmation number added to the traveler's integrated itinerary. In other cases, the ticket may be held at a will call window. There are also times where printed tickets are required and may be left in the traveler's vacation rental by the VRM.

Regardless of the type of activity or method of purchase, all activities will be included in the integrated travel itinerary available to the traveler. Instructions will be included as to the method of fulfillment, location of the activity and other relevant information.

User Interaction Cases and XML Structures

FIG. 7 depicts interaction of the system with three basic types of online inquiry/booking forms. These may be built as front ends to a single web service that takes the booking type as an argument. The first type is Inquiry Request 731. The second type is the Quote and Hold form. There should be two versions, one which requires a deposit by credit card 723 and another 733 which indicates the traveler's interest in the unit at the specified price. The final form type would be Book It Now 713, which would offer full online booking and charging of credit cards.

In the online booking scenarios illustrated by FIG. 7, the user 521 accesses the Rental Finder component 721, which we introduced in FIG. 1 as 177. The user selects from a variety of options 722. An inquiry request 731 results in a query to the VRM about the unit or property. This may be dispatched by e-mail or by system messaging 732. An online booking 713 leads the user 521 through choosing rental dates and approving pricing 714, and entry of personal data 715. Similar steps are followed for both quote and hold with deposit 723 (steps 724, 725) and without deposit 733 (steps 734, 735). A user in the process of buying may be offered additional travel services or a dynamically configured package 716, supported by the components introduced in FIG. 1. When selections have been made, the user either places a hold on the reservation (723, 724) or agrees to a contract and gives payment information 717, such as credit card information. Travel insurance sales may be handled at this stage. All three types of bookings are added to the reservation tracking database 728.

The following is a sample of the XML information which will be available to both Quote and Hold and Online Booking contracts:

```
<?xml version=“1.0” encoding=“utf-16”?>
<ContractInfo xmlns:xsd=“http://www.w3.org/2001/XMLSchema”
xmlns:xsi=“http://www.w3.org/2001/XMLSchema-instance”>
<Unit>
  <IsNewObject>false</IsNewObject>
  <UnitId>
    <IsNull>false</IsNull>
    <Value>2504</Value>
  </UnitId>
  <KkproductType>VRM</KkproductType>
  <KkproductId>
    <IsNull>false</IsNull>
    <Value>1050</Value>
  </KkproductId>
  <KkproductSubType>UNIT_ID</KkproductSubType>
  <KkproductSubId>
    <IsNull>false</IsNull>
    <Value>2</Value>
  </KkproductSubId>
  <PropertyId>
    <IsNull>false</IsNull>
    <Value>1449</Value>
  </PropertyId>
  <ManagerId>
    <IsNull>false</IsNull>
    <Value>611</Value>
  </ManagerId>
  <UnitName>Ocean Front Home (Plantation style 3/4)</UnitName>
  <Address1>75-5932 Alii Drive</Address1>
  <Address2 />
  <City>Kailua-Kona</City>
  <State>HI</State>
  <Zip>96740</Zip>
  <Country>US</Country>
  <UnitType>Null</UnitType>
  <UnitStatus>InProcess</UnitStatus>
  <ReservationPhone />
```

<ShortDescription> This home, walking distance to downtown Kailua-Kona, has 3 bedrooms 4 bathrooms, and an ocean front pool and hot tub.</ShortDescription>

<LongDescription> This home, walking distance to downtown Kailua-Kona, has 3 bedrooms 4 bathrooms, and an ocean front pool and hot tub. Each bedroom has its own full bath with a Jacuzzi tub in the master bath. This house is also equipped with air conditioning.</LongDescription>

```
<NumBedrooms>
    <IsNull>false</IsNull>
    <Value>3</Value>
</NumBedrooms>
<NumBathrooms>
    <IsNull>false</IsNull>
    <Value>4</Value>
</NumBathrooms>
<NumSleepers>
    <IsNull>false</IsNull>
    <Value>8</Value>
</NumSleepers>
<Rating>
    <IsNull>false</IsNull>
    <Value>5</Value>
</Rating>
<CheckInTime>3:00</CheckInTime>
<CheckOutTime>11:00</CheckOutTime>
<UnitUrl>http://www.trykona.com/properties.html</UnitUrl>
<ShortStayDays>
    <IsNull>false</IsNull>
    <Value>0</Value>
</ShortStayDays>
<ShortStayFee>
    <IsNull>false</IsNull>
    <Value>350.0000</Value>
</ShortStayFee>
<ShortStayFeeIsRate>
    <IsNull>false</IsNull>
    <Value>false</Value>
</ShortStayFeeIsRate>
<DepositAmount>
    <IsNull>false</IsNull>
    <Value>400.0000</Value>
</DepositAmount>
<DepositIsRate>
    <IsNull>false</IsNull>
    <Value>false</Value>
</DepositIsRate>
  <Promotions />
</Unit>
<ContactInformation>
  <FirstName>firstname</FirstName>
  <LastName>lastname</LastName>
  <Address1>addr1</Address1>
  <Address2>addr2</Address2>
  <City>city</City>
  <State>AL</State>
  <Zip>95050</Zip>
  <Country>US</Country>
  <Email>email@mail.net</Email>
  <HomePhone>301.111.1111</HomePhone>
  <WorkPhone>301.111.1111</WorkPhone>
  <CellPhone>301.111.1111</CellPhone>
  <Fax>301.111.1111</Fax>
  <NumAdults>3</NumAdults>
  <NumChildren>1</NumChildren>
  <Comments>comments go here!</Comments>
</ContactInformation>
<PricingInformation>
  <BeginDate>8/25/2005 12:00:00 AM</BeginDate>
  <EndDate>8/26/2005 12:00:00 AM</EndDate>
  <BasePrice>600</BasePrice>
  <Charges>
    <Charge>
      <ChargeName xmlns=“Controls.ExactPricing:Charge”>cleaning
      fee</ChargeName>
      <ChargeAmount
xmlns=“Controls.ExactPricing:Charge”>200.0000</ChargeAmount>
    </Charge>
    <Charge>
      <ChargeName xmlns=“Controls.ExactPricing:Charge”>Cable
Modem</ChargeName>
      <ChargeAmount
xmlns=“Controls.ExactPricing:Charge”>30.0000</ChargeAmount>
    </Charge>
    <Charge>
      <ChargeName xmlns=“Controls.ExactPricing:Charge”>Booking
Fee</ChargeName>
      <ChargeAmount
xmlns=“Controls.ExactPricing:Charge”>25.0000</ChargeAmount>
    </Charge>
    <Charge>
      <ChargeName
      xmlns=“Controls.ExactPricing:Charge”>Markup</ChargeName>
      <ChargeAmount
      xmlns=“Controls.ExactPricing:Charge”>3.2500</ChargeAmount>
    </Charge>
    <Charge>
      <ChargeName xmlns=“Controls.ExactPricing:Charge”>Test
Accrual</ChargeName>
      <ChargeAmount
      xmlns=“Controls.ExactPricing:Charge”>5.0000</ChargeAmount>
    </Charge>
  </Charges>
  <ShortStayFee>0</ShortStayFee>
  <Tax>125.1060</Tax>
  <TotalPrice>1035.83</TotalPrice>
  </PricingInformation>
</ContractInfo>
```

Three Website Integration Technologies

Three technologies for website integration are described below. One is including an IFrame that invokes either the TS Hub or Rental Finder components. Another option, expected to be used by larger sites, is exposing XML interfaces (document or RPC) to the web services. Groups using this method typically represent a large business opportunity or otherwise procure engineering/support resources. Another technology uses server-side code to dynamically create HTML pages that are undistinguishable to search engines from statically served pages. That is, to avoid using constructs that search engine spiders ignore when indexing.

Frames and IFrames

First, the IFrame element technology creates an inline frame that contains another document, a separate web page within a web page. Issues with IFrame elements include dynamically resizing an IFrame (difficult or impossible) and indexing content of IFrames for search engine retrieval (search engines are known to have problems indexing and delivering searchers correctly to sites with frames and IFrames.)

An IFrame element can be used to invoke either the TS Hub or Rental Finder components. One of the parameters for an HTML IFrame statement, which was defined beginning with HTML version 4.0 several years ago, is “src”, for the source URL of the document to be displayed in the frame. Some additional parameters define the name, height, width, framing, margins, scrolling behavior, alignment and spacing for the frame in which the document is displayed. Depending on scrolling behavior, the content delivered from the source web site may be truncated or displayed with scrolling bars that force a user to scroll around in order to see the whole page. Once an IFrame is defined on the VRM's web site, content can be requested from a web page associated with the TS Hub or Rental Finder to deliver the content and functionality disclosed.

IFrame parameters are additional pieces of information passed to the server as part of the IFrame URL. An example of this would be:

http://ts.rentoneonline.com/rentalfinderclient/searchpage.aspx?vrmName=HRM&bgcolor=00FF00

This example sets the VRM name to HRM and the background color to #00FF00. The following is a list of configuration parameters that may be supported: bgcolor—background color of the page; h1Color—color for main heading text; h2Color—color for sub headings text; textColor—color for regular text; and font—font to use (e.g., ‘Trebuchet MS, Sans-Serif’ style formatting).

To illustrate use of IFrame technology, we give the following example of parameters for the three online booking scenarios of FIG. 7. Generally, to avoid scrolling issues involved with cross-domain IFrame implementations, one may use a combination of a frame and an IFrame. The basic idea is that the frameset will contain only a single frame which will point to the Travel Services server. By using the frameset, the URL in the client browser won't change. In order to serve the page from the Travel Services server, it first reads a template page to know where to insert the new data.

To make the template page, the first step is to take the source from whatever page you would insert the IFrame into and replace the IFrame definition with the comment:

<!--TS System Content-->

The next step is to add the following comment to the <HEAD> section:

<!--TS System ResizeScript-->

Once you have added the necessary parts to the template, you will need to modify the links and images contained within it. All of the images will need to be converted to absolute URLs (since they will now be served from a different server). For all hyperlinks, they will need to have the ‘target=top’ directive added to them.

If you want to use a frameset, you should only submit the information within the frame you wish to have supplied by Travel Services. For instance, if you had a list of properties in the left-hand frame and you wanted to display the descriptions to the right, you would still use a frameset on the client site, and then use the appropriate client template for the content of the right-hand frame.

For an inquiry request, configure the Frame with the following values:

```
src= “http://ts.rentoneonline.com/RentalFinderClient/
RentOneOnlineFrame.aspx”
src=”http://ts.rentoneonline.com/RentalFinderClient/InquiryRequest.aspx”
Items to append to URL in ?name=value&name2=value2 format include:
    prodType = 1 (for VRM edition)
    prodID = ClientID (as found in the CLIENT table
    in ROO_COMMON)
    prodSubID = UnitId (as seen in the VRM's unit listing)
    PageURL = /RentalFinderClient/InquiryRequest.aspx
name = “main”
target = “main”
```

For quote and hold or book it now, configure IFrame with the following values:

```
src=”http://ts.rentoneonline.com/RentalFinderClient/
RentOneOnlineFrame.aspx
Items to append to URL in ?name=value&name2=value2 format
    prodType = 1 (for VRM edition)
    prodID = ClientID (as found in the CLIENT table
    in ROO_COMMON)
    prodSubID = UnitId (as seen in the VRM's unit listing)
    PageURL = /RentalFinderClient/ OnlineBooking.aspx
    if Quote and Hold, qh=1 (otherwise nothing required)
name = “main”
target = “main”
```

These examples should help one understand an IFrame implementation strategy.

Another configuration option will be using CSS-based style sheets. One of the optional parameters passed to the IFrame definition can be a link to a style sheet located on the customer's web server. This will allow them (or their webmaster) to configure all colors, fonts, font sizes and other non-layout options for text and textboxes. This configuration option will not allow for controlling what gets displayed or where it will appear on the page. It also will not allow any addition of text to the page. This option will usually be implemented in conjunction with other IFrame parameters.

Alternatively, XSLT-based style sheets may be used. This is a flexible option that involves generating the XSLT and uploading it. It will allow complete styling of data as well as adding additional text to pages or moving data around the page. This will allow an exact match to a customer's existing website and unit description.

Web Services

Second, a collection of web services interfaces may be exposed with a VRM or system sponsored web page using the web services approach to populate pages. In one embodiment, online booking can be integrated into a backend system that handles accounting, vendor relations and similar issues. Online booking in this embodiment will be handled by web services. The Rental Finder and TS Hub will be subscribers to this web service.

To integrate web services into an existing backend system, a new main tab for travel services may be added to a home page. For a non-integrated VRM system, this tab may be implemented as a stand alone web page. This tab may contain two sub headings: VRM Information and Publish Units.

The VRM Information page will contain the basic information about the VRM that will be published. This will include things like the VRM name, address, phone number, description and a link to their website. It will also include the ability to upload a logo for display on the search results listing page and optionally a photo to use on the unit description page. The default booking method and maximum days it can be booked in advance may be specified here.

The Publish Units page will contain a data grid of the units in the system. Units will have a status of publish, unpublish or error. An error condition may result from reservations being entered but not communicated successfully to the travel services server (an outage on the travel services side should not affect the ability of the VRM edition to function). There will also be a link to view the unit as it would be published in travel services and one to publish/unpublish/update the unit as appropriate for each given status.

A view unit link will go to a page which will pull both the short listing used on the search listings page and the longer description found on the unit description page. None of the information will be editable from this screen but there will be a link to the unit_details page. Any time a unit is published, the user will first have to view this screen and then click the publish button at the bottom of the page.

A seasonal_pricing_detail page is a logical place to specify the type of booking allowed for a unit (ERequest, Quote and Hold, Book it Now). Each season will need to allow the VRM to specify the appropriate booking method. In some cases, special seasons may not allow direct online booking. A default value should be set in the travel services section and applied to all units if they do not already have a value.

A unit_details page will be adapted to support travel services. It will have a drop down list to specify unit type (condo, house, etc). It will also display amenities to conform to the standard/custom and amenity/activity distinctions in Rental Finder. An optional piece of the user interface would be adding a checkbox to each standard activity or amenity which will determine if it is displayed on the unit description page in Rental Finder or the unit flyer.

On the unit_details page a number of hooks will be available. A general submit button will fire the UpdateUnitDescription web service method as well as the UpdateUnitPricing web service method. Changes to taxes, pricing, or charges will each call the UpdateUnitPricing web service method.

A seasonal_pricing master page will result in the UpdateSeasons web service method being sent a new set of seasons.

A reservation_details page handles creating, deleting, or changing a reservation. It will call the appropriate web service methods. Deleting a reservation will fire the UnPublishUnitReservation web service method.

These web services will be contained in a travel services assembly deployed as Web Service Objects. The TSUnitId is transmitted in most web service methods to describe which unit the method is updating. The current description uses the KKProduct nomenclature but published specs will use less internal naming conventions (but since KKProduct names are used in other projects it clarifies the description for internal uses). Sample:

```
<TSUnitId>
    <KKProductType>VRM</KKProductType> // VRM, PVRM, etc
    <KKProductId>1001</KKProductId> // VRM client Id
    <KKProductSubId>15</KKProductSubId> // VRM edition UnitId
</TSUnitId>
```

The TSUnitDescription contains the basic information for the unit. The short description will be used for the search results page while the long description will be displayed on the unit description page. Sample:

```
<TSUnitDescription>
    <PropertyId>205</PropertyId>
    <UnitName>Taj Mahal</UnitName>
    <Address1>100 Grand Street</Address1>
    <Address2>Suite 200</Address2>
    <City>Agraville</City>
    <State>Agra</State>
    <PostalCode>2010-1A</PostalCode>
    <Country>IN</Country>
    <ReservationPhone>05-1202-10013</ReservationPhone>
    <ShortDescription>Luxury Accommodations...</ShortDescription>
    <LongDescription>A wonderful
    place...</LongDescription<Bedrooms>102</Bedrooms>
    <Baths>32.5</Baths>
    <Sleeps>165</Sleeps>
    <Rating>5</Rating>
    <CheckInTime>14:00</CheckInTime>
    <CheckOutTime>10:00</CheckOutTime>
    <Url>http://www.indiatours.com/tajmahal</Url>
</TSUnitDescription>
```

The TSUnitPricing object will contain all of the pricing information about the unit. Everything from seasonal pricing to taxes and charges may be included in this object. The seasonal pricing will also hold information about the appropriate booking method to offer for that season. Components of the pricing will be marked as being insurable or not for later incorporation of travel protection (with the exception of seasonal pricing and short stay fee, both of which comprise the base rent which is always insurable). Any special charge types will all be transmitted to travel services as generic charges. Sample:

```
<TSUnitPricing>
    <SeasonalPricings>
    <SeasonalPricing>
        <SeasonId>13</SeasonId>
        <WeekdayPrice>100.00</WeekdayPrice>
        <WeekendPrice>150.00</WeekendPrice>
        <WeeklyPrice>700.00</WeeklyPrice>
        <MonthlyPrice>2500.00</MonthlyPrice>
        <BookingMethod>QuoteAndHold</BookingMethod>
    </SeasonalPricing>
    </SeasonalPricings>
    <ShortStayFee>
        <MinimumDays>5</MinimumDays>
        <Amount>50.00</Amount>
        <Type>FixedCharge</Type>
    </ShortStayFee>
    <Deposit>
        <Amount>200.00</Amount>
        <Type>FixedCharge</Type>
    </Deposit>
    <Taxes>
    <Tax>
        <Name>HI State Tax</Name>
        <Amount>5</Amount> // Always a percentage
        <Insurable>True</Insurable>
    </Tax>
    </Taxes>
    <Charges>
    <Charge>
        <Name>Cleaning Fee</Name>
        <Amount>25.00</Amount>
        <Type>FixedCharge</Type> //Also PercentageCharge
        <Tax> // Charges can have tax on them too
            <Name>HI State Tax</Name>
            <Amount>5</Amount> // Always a percentage
            <Insurable>True</Insurable>
        </Tax>
</Charge>
</Charges>
</TSUnitPricing>
```

The TSUnitAmenities object will contain both standard and custom amenities. The standard amenities will be used in searches. The custom amenities may optionally be searched and are displayed on the unit description page. All amenities will have a value field. For amenities like hot tub, the values would be Yes or No. For amenities like TVs, an actual value will be required. Sample:

```
<TSUnitAmenities>
    <StandardAmeneties>
        <StandardAmenity>
            <Name>Hot Tub</Name>
            <Value>True</Value>
            <Display>True</Display>
        </StandardAmenity>
    </StandardAmenities>
    <CustomAmenities>
        <CustomAmenity>
            <Name>DogKennels</Name>
            <Value>2</Value>
        </CustomAmenity>
    </CustomAmenities>
</TSUnitAmenities>
```

The TSUnitActivities object will be similar to the TSUnitAmenities object. It will have a standard list and will also support custom activities. Sample:

```
<TSUnitActivities>
    <StandardActivities>
        <StandardActivity>
            <Name>Skiing</Name>
            <Distance>10</Distance>
            <Units>Miles</Units>
            <Display>True</Display>
        </StandardActivity>
    </StandardActivities>
    <CustomActivities>
        <CustomActivity>
            <Name>Beach Volleyball</Name>
            <Distance>.25</Distance>
            <Units>Miles</Units>
        </CustomActivity>
    </CustomActivities>
</TsUnitActivities>
```

The TSUnitReservation object will be generated for the Publish/UnPublish/UpdateUnitReservation web service methods. An array of TSUnitReservation objects will also be used in the PublishUnit web service method. One important note about TSUnitReservation is that the BeginDate and EndDate should reflect the nights for which reservations should not be accepted. Thus, if a traveler begins her stay on Jan. 1, 2005 and leaves on Jan. 5, 2005 but the unit is available for occupancy on the same day as departure, then the BeginDate will be Jan. 1, 2005 and the end date will be Jan. 4, 2005. Sample:

```
<TSUnitReservation>
    <ReservationId>105</ReservationId> // Used only for integrity
    checks
    <BeginDate>05/15/2005</BeginDate>
    <EndDate>05/30/2005</EndDate>
</TSUnitReservation>
```

The TSManagerInfo object contains information about the management company, or in the case of a rent by owner property, the owner information. It is transmitted once before the first unit is published, and is updated as necessary. Sample:

```
<TSManagerInfo>
    <KKProductType>VRM</KKProductType>
    <KKProductId>10001</KKProductId>
    <Name>Hawaii Vacations Unlimited</Name>
    <Address1>100 Peaceful Way</Address1>
    <Address2>Suite 200</Address2>
    <City>Kona</City>
    <State>HI</State>
    <PostalCode>20101</PostalCode>
    <Country>US</Country>
    <Phone>302-555-1212</Phone>
    <Fax>301-555-1213</Fax>
    <Description>Over 30 years experience...</Description>
    <Url>http://www.hawaiiunlimited.com</Url>
</TSManagerInfo>
```

The TSSeasons object reflects vacation seasons, which may be global for a particular VRM or owner. These will be initially set when the VRM first publishes a description of their business and then updated whenever seasons are modified. The SeasonType will denote the difference between primary seasons and special override pricing. Sample:

```
<TSSeasons>
    <KKProductType>VRM</KKProductType>
    <KKProductId>1001</KKProductId>
    <Seasons>
    <Season>
      <SeasonId>12</SeasonId> // From VRM edition
      <SeasonName>Winter 2005</SeasonName>
      <BeginDate>11/01/2005</BeginDate>
      <EndDate>02/28/2006</EndDate>
      <SeasonType>Primary</SeasonType>
    </Season>
    <Season>
      <SeasonId>13</SeasonId>
      <SeasonName>Christmas</SeasonName>
      <BeginDate>12/23/2005</BeginDate>
      <EndDate>12/28/2005</EndDate>
      <SeasonType>Override</SeasonType>
    </Season>
</Seasons>
</TSSeasons>
```

Applying the TSProperty object, units will be members of a property. The user will have the ability to view units in a property across VRMs in a general search site. The property name must be consistent across units controlled by a VRM and/or across VRMs. Sample:

```
<TSProperty>
    <KKProductType>VRM</KKProductType>
    <KKProductId>1001</KKProductId>
    <PropertyId>205</PropertyId> // As defined by VRM edition
    <PropertyName>Aloha Condos</PropertyName>
    <Description>A sunny place...<Description>
    <Address1>101 Sunny Way</Address1>
    <Address2>Beach Front Complex</Address2>
    <City>Kona</City>
    <State>HI</State>
    <PostalCode>20101</PostalCode>
    <Country>US</Country>
    <Url>http://www.hawaiiunlimited.com/AlohaCondos</Url>
</TSProperty>
```

The TSReturnStatus is a value returned from any web method. It indicates whether the function was successful and denotes the error if one occurs. Sample:

```
<TSReturnStatus>
    <Status>Failed</Status>
    <StatusCode>2001</StatusCode>
    <Message>Unable to reach travel services server. </Message>
</TSReturnStatus>
```

The TSSearchCriteria object represents the search criteria used to return available rentals and rank them appropriately. Many of the fields are optional and are marked as such. The importance ratings will be used in ordering results from fuzzy logic searches. Importance is always optional and ranges from 1-100. Sample:

```
<TSSearchCriteria>
    <Availability Importance=100>
      <ExactDates> //Optional
        <StartDate>02/10/2006</StartDate>
        <EndDate>02/16/2006</EndDate>
        <IncludePartialResults>True</IncludePartialResults>
      </ExactDates>
      <FlexibleDates> //Optional
        <SearchStartDate>02/01/2006</SearchStartDate>
        <SearchEndDate>03/01/2006</SearchEndDate>
        <NumberOfNights>5</NumberOfNights>
        <FirstNightOfTrip>Friday</FirstNightOfTrip> //Optional
      </FlexibleDates>
    </Availability>
    <Price Importance=80> //Optional
      <TotalMinimum>1500</TotalMinimum> //Optional
      <TotalMaximum>2500</TotalMaximum> //Optional
      <NightlyMinimum>150</NightlyMinimum> //Optional
      <NightlyMaximum>250</NightlyMaximum> //Optional
    </Price>
    <Accommodations Importance=100>
      <NumberOfBedrooms>3</NumberOfBedrooms>
      <NumberOfBaths>2.5</NumberOfBaths>
      <NumberOfSleeps>5</NumberOfSleeps>
      </Accommodations>
    <Amenities Importance=50>
      <Amenity>Hot Tub</Amenity>
      <Amenity>Pool Table</Amenity>
    </Amenities>
    <Activities Importance=90>
      <Activity>Skiing</Activity>
      <Activity>Beach</Activity>
    </Activities>
</TSSearchCriteria>
```

The TSShortUnitDescription object is returned from the SearchUnits web service method. Sample:

```
<TSShortUnitDescription>
    <UnitId>15</UnitId> //Unit ID from Travel Services
    <UnitSearchRating>95</UnitSearchRating> //Fuzzy logic results
    <PropertyId>205</PropertyId> //Propety ID from Travel Services
    <UnitName>Taj Mahal</UnitName>
    <City>Agraville</City>
    <State>Agra</State>
    <PostalCode>2010-1A</PostalCode>
    <Country>IN</Country>
    <ReservationPhone>05-1202-10013</ReservationPhone>
    <ShortDescription>Luxury Accommodations...
    </ShortDescription<Bedrooms>102</Bedrooms>
    <Baths>32.5</Baths>
    <Sleeps>165</Sleeps>
    <Rating>5</Rating>
    <Url>http://www.indiatours.com/tajmahal</Url>
    <Manager>
      <ManagerId>115</ManagerId> //From Travel Services
      <Name>Hawaii Vacations Unlimited</Name>
    <Phone>302-555-1212</Phone>
      <Url>http://www.hawaiiunlimited.com</Url>
    </Manager>
    <Price>
      <BasePrice>2500.00</BasePrice>
      <ChargesAndTax>212.50</ChargesAndTax>
      <ExactPrice>True</ExactPrice>
      <BookingMethod>QuoteAndHoldWithDeposit</BookingMethod>
    </Price>
<TSUnitAmenities>
    <StandardAmeneties>
      <StandardAmenity>
        <Name>Hot Tub</Name>
        <Value>True</Value>
        <Display>True</Display>
      </StandardAmenity>
    </StandardAmenities>
    <CustomAmenities>
      <CustomAmenity>
        <Name>DogKennels</Name>
        <Value>2</Value>
      </CustomAmenity>
    </CustomAmenities>
</TSUnitAmenities>
<TSUnitActivities>
    <StandardActivities>
      <StandardActivity>
        <Name>Skiing</Name>
        <Distance>10</Distance>
        <Units>Miles</Units>
        <Display>True</Display>
      </StandardActivity>
    </StandardActivities>
    <CustomActivities>
      <CustomActivity>
        <Name>Beach Volleyball</Name>
        <Distance>.25</Distance>
        <Units>Miles</Units>
      </CustomActivity>
    </CustomActivities>
</TsUnitActivities>
</TSShortUnitDescription>
```

The TSRental Finder component 177 may use several Web Service Methods. For instance, a PublishGeneralInfo(TSManagerInfo, TSSeasons, TSProperty[ ]) service publishes vacation rental manager information and season pricing information to our servers, which must be called before being able to publish information to the Travel Services servers.

A UpdateManagerInfo(TSManagerInfo) service updates vacation rental manager information on our servers for units that have previous been submitted.

An UpdateSeasons(TSSeasons) service updates vacation rental unit activities on our servers for units that have previously been submitted.

An UpdateProperty(TSProperty) This service updates the information for a property.

A PublishUnit(TSUnitId, TSUnitDescription, TSUnitPricing, TSUnitAmmenities, TSUnitActivities, TSUnitReservation[ ]) service publishes vacation rental unit information to our servers to be used as search criteria in vacation rental searches.

An UnPublishUnit(TSUnitId) service unpublishes vacation rental unit information from our servers and will no longer be used as search criteria in vacation rental searches.

An UpdateUnitStatus(TSUnitId, Status) can be invoked when a unit is initially published, to set its status to unpublished. This allows the VRM to view how it will be published once the publication of the unit is approved. This method gets called after the VRM chooses to publish the unit and then approves the unit as it will be displayed to the traveler. It is also used when unpublishing a unit.

An UpdateUnitDescription(TSUnitId, TSUnitDescription) service updates vacation rental unit information previously submitted to our servers.

An UpdateUnitPricing(TSUnitId, TSUnitPricing) service updates vacation rental unit pricing on our servers for units that have previously been submitted.

An UpdateUnitAmenities(TSUnitId, TSUnitAmenities) service updates vacation rental unit amenities on our servers that have previously been submitted.

An UpdateUnitActivities(TSUnitId, TSUnitActivities) service updates vacation rental unit activities on our servers for units that have previously been submitted.

A PublishUnitReservation(TSUnitId, TSUnitReservation) service publishes a reservation to our servers for already submitted units to be used as search criteria in vacation rental searches.

An UnPublishUnitReservation(TSUnitId, TSUnitReservation) service deletes a reservation from our servers that has previously been published.

An UpdateUnitReservation(TSUnitId, TSUnitReservation) service will simply unpublish and republish a reservation. The web method is only provided as a convenience and for consistency with other update methods.

A GetUnitDescriptionPage(TSUnitId) service will return the unit description page. It will be used both to generate the unit description page for a traveler as well as to verify that the information is correctly formatted before publishing.

A GetUnitSearchListing(TSUnitId) service will return the short description of the unit as it would appear on a search results page. It will be used to display the search results page to a traveler as well as to verify that the information is correctly formatted before publishing.

Content Conveyor

A third technology for web site integration, content conveyor objects is illustrated in the CD-ROM appendix files RooPage.txt and Unit34.txt. The RooPage.txt file previously was named RooPageCore.cs. The Unit34 file is an aspx file. These files can be viewed with color coding using Microsoft's Visual Basic for Web Services tool.

The content conveyor technology has benefits over the IFrame technology. IFrame integration of Rental Finder into a customer website is fairly complicated and lacks flexibility. With IFrame technology, implementation involves adding a single page to the customer website which holds all Rental Finder components. It contains a frame that occupies the entire page that then links to a page on the Travel Services site. A programmer then creates a template matching the current look and feel of the customer website (including page headers, footers, etc.). Within that page, A programmer adds tags for content to be inserted by the Travel Services engine. Those tags are replaced by an IFrame that contains dynamic content generated by Rental Finder.

This methodology involves taking a snapshot of the VRM website and uploading it as a template which is no longer modifiable by the VRM. If the VRM added a tab to their header, they would need to contact the system operator to have that tab added to the template.

A significant issue is that pages implemented with IFrame technology are not able to be indexed by search engines. In the VRM travel segment, search engine ranking is very important and while they may not take most of their reservations online, many originate from customers finding their website online. In order for the search engines to index the site, we will need to make it appear that all of the content is generated directly from the customer website (even if it actually comes from Rental Finder).

IFrame integration also lacks the ability for us to track travelers on the VRM website as we only work within a single frame which is put on that page using a static URL. This limits our ability to generate analytics which can help our customers better understand where their actual bookings originate.

In one embodiment, content conveyor objects are implemented using a Microsoft ASP.Net server and code behind pages to dynamically populate a web page, without need for use of frame or Iframe tags. A content conveyor object dynamically populates the web page with the content that could otherwise be generated using an IFrame to retrieve content from another web site. Only the HTML and tags that would be included within the IFrame is dynamically composed. The surrounding HTML will be on the actual page rather than included in the template that includes the IFrame.

Dynamically populating the web pages allows search engine robots to better index the site. Including multiple means of reaching each property produces a higher link count within the VRM website. The increased link count improves a VRM's search rankings as we can dynamically generate page hierarchies that could not reasonably be maintained by hand.

A basic search box can be implemented on the main page of a VRM website using a content conveyor object. The VRM would be able to edit site pages using standard tools, so long as the edits preserve the special tags that implement the content conveyor object, so that it continues to be replaced by data from Rental Finder. Enhancements to a main web page, such as selecting a couple properties from inventory to display on the VRM's main page that can have short listings, can also be implemented.

This integration strategy supports delivery of rich and dynamic content to a VRM website hosted on an external server, while still centralizing the Travel Services platform and content on the system operator's servers. The VRM website appears to all viewers and search indexing bots to be a very powerful and feature-rich website with real-time content, without resorting to html frames or links to external sites to perform complex operations (such as searching, online booking, and credit card processing). In fact, even if the user looks at the HTML source for the page, they still would not see any artifacts of the content conveyor object that delivers content from the Travel Services platform. This is a distinct contrast to the alternatives of frames and links to external domains used by other implementations. Therefore, the user is able to view and perform many advanced features, and the VRM is able to have a simple and manageable site to maintain.

Channel Pricing Code Tracking

One general need of VRMs and other web-based vendors is the ability to track online bookings back to the advertising source. Currently, vendors typically include a tag on the URL associated with the advertisement so they can see, for instance, that they took in $XXX in bookings from a banner ad which costs $50/month.

Content conveyor objects with a common page behind provide similar information only better! If a traveler comes from that banner ad and then decides to look around the site for a while and eventually book a different unit, we can still correctly mark the reservation with the appropriate channel code. Analytics can be performed both on the source level (the VRM website) as well as the channel codes booked through that source.

One features will be the ability to measure search engine purchased term effectiveness (term is used here to refer to the combination of words which the VRM pays a search engine to advertise; Google refers to these as “ad words”). We will be able to assign a channel code to each purchased search engine term and then track total revenue generated from that term. Often times the most expensive terms will result in the least number of bookings. For instance, if the VRM purchases ‘Florida Rentals’, they are likely to pay for clicks from people looking for rentals in cities they do not service. Less expensive terms such as “Miami Vacation Rentals” may actually result in more bookings at a far lower cost.

With little effort, this new integration technology supports generation of the basic information that can be used for very powerful analyses of the VRM website. Some possible uses include tracking a customer's total time on a site and number of page views (important for analyzing “stickiness” of the site), tracking the number of times a particular property is viewed (a good way for a VRM to show their customers how much they are doing to improve total bookings), and tracking the progress of a traveler through the site so it can be better optimized. The content conveyor objects (called “active objects” in the accompanying CD-ROM appendix files) generate the basic statistics to which website stats packages and measures can be applied, with the advantage of being able to see what actually results in a booking and how many additional items are sold, beyond the advertised item.

Conversion of Existing Websites to Content Conveyor Technology

A software tool converts HTML pages of an existing web site into ASPX (asp.net) pages. In the CD-ROM appendix, the files convert-cs.txt and convert-aspx.txt facilitate conversion of HTML into ASPX codes. In part, the tool adds a line to the top of the file and a form tag. Files that already include a form tag (such as a comments submission page) require special handling. In most cases it isn't essential that these be tracked, but if they are, they will either need to be rewritten to be compatible with asp.net or a shell page will need to be created which just redirects to the HTML page (even though the HTML page cannot be tracked, the .aspx page that forwards to it will be trackable). The contents of the file will remain regular HTML directly copied from the existing file.

A series of tags called “content conveyor objects” will be created that can be added to the page and replaced by dynamically generated content at runtime. There will be content conveyor objects available for short unit listings (similar to those returned from a search request), manager listings (similar to the page found on TryKona.com), unit details pages and both a basic and an advanced search. For each of these content conveyor objects, programmers will be able to generate an unlimited number of templates. These content conveyor objects will take the same arguments as any existing Frame-based integrations (i.e., the search object takes the same arguments as those supplied in the Frame URL used for a search page integration).

HTML to ASPX Converter

The first step will be to create an application that will crawl a site given a starting directory and process any HTML. It should operate on a local file system copy of the website. An exact list of file extensions which represent HTML pages will need to be determined, but it should definitely include .HTML, .HTM, .DHTML pages, as well as others. The crawler should also flag other types of files which it may not be able to convert to .aspx pages. These would include Cold Fusion pages, pages using server side includes, etc.

Before processing an HTML page, we should determine if there is anything preventing us from being able to process it. Any pages which cannot be processed should be flagged for Conversion staff so that they can either modify the page so it can be processed or be aware that some pages will need to remain HTML pages. Things we should be looking for include:
1. Any pages which are interpreted by a server and then delivered as HTML (i.e., Cold Fusion pages)
2. Any pages including Server Side Includes (some server settings will allow these in regular .html pages, so we'll actually need to look inside to make sure there aren't any SSI directives)
3. Any pages containing a form tag (.aspx pages can only have a single form tag, and adding a second form tag from the existing html page would violate this rule (as seen in step 4 of the .aspx conversion outlined below))
4. Pages containing Javascript should be converted, but should be flagged separately so that Conversion staff is aware that there is the possibility of problems (the possibilities are fairly remote, but it is important for Conversion staff to be aware of that possibility)
5. Pages containing links to CSS files external to the VRM's website should be flagged, but still converted (since we are unable to do any processing of these CSS files, it is possible they may have unprotected tag definitions such as TD which could interfere with the dynamically inserted HTML from the Rent One Online servers)

Once an HTML page is targeted to process, it will go through the following steps:
1. Change the file extension to .aspx
2. Insert the @PAGE directive line at the top of the file
3. Add MS_POSITIONING=“FlowLayout” to the body tag
4. Add a <FORM> tag directly below the <BODY> tag and a </FORM> tag directly above the </BODY> tag
5. Any URLs which point to HTML pages on the customer site will need to be pointed to the new .aspx pages.

Content Conveyor Object Format

Content conveyor objects will be represented as <asp:panel> tags with a specially coded ID and an additional ‘vars’ attribute. So, if a programmer wants to include a basic search in the main page on a website, they would layout the entire page first as raw HTML. When they determine the location for the dynamic content (usually inside a table cell), they would add a panel with a specific id tag. An example might be:

```
<table>
  <tr>
    <td>
      <!--Content conveyor object-->
      <asp:panel id=”pnlRentOneOnline_searchpage2_1”
      vars=”price=6&amenities=1+3+5”>Conversion staff can put any
      content they like in here if they're using an external design
      program...</asp:panel>
    </td>
  </tr>
</table>
```

Some parts of the content conveyor object include:
Panel ID tag—we will iterate through the controls collection for the page (ASP.Net has a control-based architecture for dynamically generating an Html page) looking for anything with an ID that begins with “pnlRentOneOnline_”. We will then look at the next string “searchpage2” to determine what kind of content to insert. This will map to one of the template definitions uploaded by Professional Service. The “_{—}1” will be ignored; it is only there so that we don't have multiple panel tags with the same ID. If there are additional content conveyor objects that use the same template, the “_{—}1” will be incremented for each object.
vars—This will contain the exact same string as is passed as part of the URL for current IFrame integrations. We will want to setup a property on any page that reads the GET parameters for an integration page such that it returns either the values from the GET parameters or from the ‘vars’ variable on the panel tag.
Any information inside the <panel> tag will be overwritten by the dynamic content. This should allow Conversion staff to include sample static HTML so they can work on the page layout in an external program (since <asp:panel> is an unknown tag, browsers should just ignore it if they don't recognize it)

Content Conveyor Object Tags

There will be a number of possible content conveyor object tags. The basic tags may include search, shortlisting, and longlisting. Each may be followed by any natural number (1, 2, 3 . . . ). If a programmer wishes to support 3 search pages for a customer, they may create templates for search1, search2 and search3. We will look at the content conveyor object tag and attempt to pull the correct template. If there is no template for search3, then an error should be returned stating that we were unable to find the template. Alternatively, the system may invoke a default template.

We will maintain default templates for search1 (basic search), search2 (advanced search), shortlising1 (formatted with a lesser width so they can fit two to a page or have text to the side of them), shortlisting2 (used for search results) and longlisting1. A programmer can override any of these templates or add an unlimited number of additional templates of any of the supported formats.

Common Code-Behind

Typically, .aspx pages on the VRM website will inherit from a common code-behind page. This code-behind will provide two primary functions: content conveyor object processing and website visitor tracking.

Content conveyor object processing is a proxy-like architecture in which the VRM server simulates the actions of a typical web browser. The application residing on the VRM website will take input from the traveler, it will then act as a web browser itself and pass that data to the Travel Services server. The data returned by Travel Services will be processed by the client application on the VRM server and then presented to the traveler. If the traveler clicks a button inside the HTML for that content conveyor object, the VRM website application will bundle up the request from the traveler and pass it back to Travel Services and again display the response to the traveler through the same process.

This proxy-like architecture will need to maintain the ViewState returned by the Travel Services server. This should be stored in a hidden form field on the page with the name ‘TS_ViewState’. This ViewState will be returned to the Travel Services server with page requests after the initial request.

Content Conveyor Object Processing: Step by Step

For this example, we will discuss the integration of a standard search engine page. The sequence of events will begin when the processor scans a page for content conveyor objects on page load. It will do this by iterating through the Page.Controls collection and processing any <asp:panel> tags which conform to the content conveyor object syntax. When the application first starts, it will need to contact a web service in Travel Services to obtain the correct page in Travel Services to process each type of template.

When the page first loads and the code-behind reaches an content conveyor object it needs to process, it will lookup the appropriate URL from application scope (in the VRM server memory as obtained from the web service just mentioned) to process that type of template. It will then append the value of the ‘vars’ attribute of the <asp:panel> to the URL as a query string. This will exactly match the URL used for the IFrame in a Frames-based integration.

The processor will then request a page from Travel Services associated with that content conveyor object. When that page is returned, the processor will strip out any tags that aren't appropriate to insert into the middle of an HTML page (<HTML>, <BODY>, <FORM>, etc.). It will then clear the panel's controls collection (to remove any HTML inserted by Conversion staff between the <asp:panel> and </asp:panel> tags). The HTML returned will then be added to the panel's controls collection as a literal control (a literal control just outputs the “literal” html content assigned to it without manipulating it in any way).

At this point, the traveler has a search form generated by Travel Services using the template created by Conversion staff. When the traveler enters his or her search criteria and clicks search, the page will post back to the VRM website application. The forms collection posted back to the server will include all of the information required for Travel Services to process the search request.

The application will then format another request to the Travel Services server. This time it will need to include the appropriate form variables just as if it was a browser returning the form variable collection directly to the server as part of a post event. It will take the forms collection returned to it by the traveler and change the TS_ViewState entry back to _VIEWSTATE. The application will then make a page request from the Travel Services server again with the new form post data.

This will continue as the user continues to interact with the page. There should be no limit to how long this interaction may continue.

The basic search will actually support a new parameter: the page to display the results. So far, we have discussed content conveyor objects that return data from the Travel Services server into their existing panel. The panel for a basic search hosted on the VRM homepage will be too small to display the search results. Instead they will need to be displayed on another page with a content conveyor object of its own.

In order to handle this, the content conveyor object on the first page will have to initiate a Server.Transfer( ) method call to the page for the search results. That page will then read the form variables from the first page and return them to the Travel Services server as discussed earlier. From that point forward, the page URL will not change and everything will continue as normal.

Visitor Tracking

Since each visitor will automatically have a session created when they first reach the site, visitor tracking is a matter of writing the appropriate data into session and then transmitting it to Travel Services on session end. We will want to make sure that every visitor is sent a persistent cookie that can be used to identify them if they return after their existing session has timed out. We will need to track the following information:
The referred by link for the first page visited on the VRM website
The URL and timestamp for every page visited
Any channel code present in the URL for the first page visited

When the visitor's session times out, the session end handler in global.asax (a common page in the ASP.Net architecture) will send the appropriate information back to the Travel Services server. We will need to record the page view information as well as the channel code. This allows us not only to see how many bookings come from a particular source, but how many visitors actually reach the site and do not book a vacation rental online.

### Some Particular Embodiments

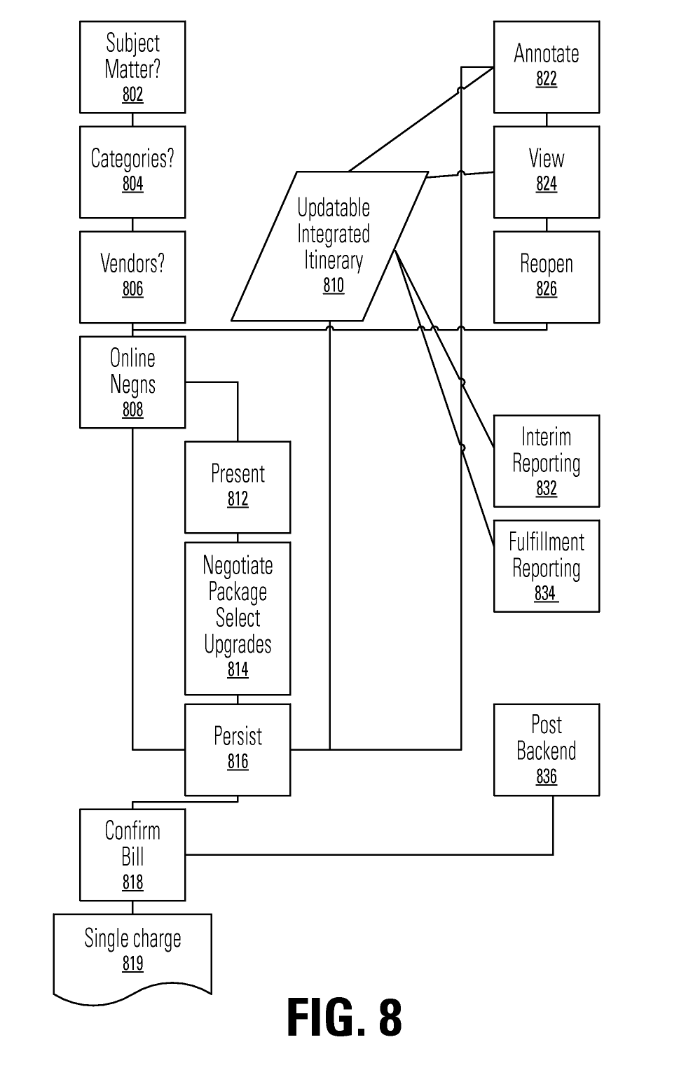

FIG. 8 is a high level flowchart of persisting and updating an updatable itinerary data structure that records online negotiations between a consumer and multiple distinct travel-related vendors. By updatable itinerary data structure, we mean both a single data structure, such as a record in memory, a DOM tree or a nested XML document, and a multi-part data structure, such as entries in a group of related tables in a relational database. By negotiations, we mean both a simple offer and acceptance and a negotiated package price. These negotiations may be between either a user or a user's agent, on one hand, and one or more vendors, on the other hand.

In one embodiment, the method proceeds with identifying a travel-related subject matter of interest 802, identifying purchase categories 804 within the travel-related subject matter and identifying relevant vendors 806. One or more relevant vendors may be identified. For purposes of illustration, this method is described in the context of negotiations with at least two particular vendors in at least two particular purchase categories. In a first network session, there could, alternatively, be one vendor in one purchase category or three or more vendors in three or more purchase categories. The vendors with whom negotiations are consummated are distinct vendors and are in different purchase categories, such as vacation rental, airfare, car rental or rafting activities. During the first network session, the method includes intermediating negotiation online 808 between a user or user's agent (collectively referred to as the user) and at least first and second vendors in different purchase categories. For vendor, the method includes sending the user the vendor's offerings 812, including availability and pricing and receiving the user's selection of a particular offering. The method includes channeling messages between vendor and the user, such as receiving the vendor's offerings before sending them and sending the user's selection after receiving it. A negotiation or purchase is carried out 814. The method further includes persisting 816, as an item in memory of an intermediator's server 810, confirmation of the intermediated negotiation. The item persistent forms part of an updatable itinerary data structure. The method continues in a second network session with the user. The second network session includes accessing the updatable itinerary data structure 810 and sending the user of formatted version of items in the updatable itinerary data structure, plus at least one control for adding an item to the data structure. Alternatively, it may include sending at least one control for changing an item 826 in the data structure. It continues, responsive to a message indicating that the user has selected the control, with an appropriate response. If the user has selected the control for adding an item, the method continues with repeating 808 the sending, receiving, channeling and persisting actions. This results in adding to the updatable itinerary data structure, as additional items, confirmations of additional intermediated negotiations with one or more additional vendors. If the user has selected the control for changing an item, the method continues with reopening negotiations 826 between the user and at least one vendor. Intermediating renegotiation online between the user and the vendor includes repeating the sending, receiving, channeling and persisting actions, thereby changing an item in the updatable itinerary data structure and adding a confirmation of the renegotiation. When the user is ready to checkout, the total can be confirmed and billed 818.

A further aspect of this method embodiment may include persisting in the updatable itinerary a vacation rental reservation, meaning a rental of a vacation home, beach house or condominium, as a result of one of the intermediated online negotiations. In some embodiments, a first intermediated negotiation, before any other items are added to the updatable itinerary, may be the vacation rental reservation. The intermediator may be a licensed as a travel agent and may aggregate billing of multiple items to the user in a single charge 819. In many states, only a licensed travel agent, with licensing approval in the United States by Homeland Security, is authorized to consolidate multiple items from distinct vendors into a single charge.

Applicable to any of the method embodiments described above, adding to the updatable itinerary may further include presenting the user additional purchase category offerings that are geographically proximate to a location of the vacation rental reservation. When presenting geographically proximate additional purchase category offerings, the method may include identifying at least one airport that is geographically proximate to the location of the vacation rental reservation and presenting at least one airport-related purchase category in the context of the identified airport. For instance, this may include a flight reservation or a rental car reservation.

Also applicable to any of the method embodiments described above, age information for travelers may be collected and the user may further be presented with activity offerings that are appropriate to the travelers' age information.

In one interaction mode, a represented user has a user's agent conduct online negotiations. The updatable itinerary may be made available to both the represented user and the user's agent. The user's agent may be authorized to add helpful information to the updatable itinerary data structure and persist it for viewing by the represented user. When a represented user independently arranges some activities, those activities may be secured so that the represented user sees 824, has access to or may edit 822 the independently arranged activities, and the user's agent has less or no access to the independently arranged activities.

The method can be enhanced by supporting the user's agent in arrangement of activities that are not bookable online. For instance, a local cross-country ski shop may take reservations by telephone, but not online. The method may include presenting online to the user's agent activity options consistent with dates for the vacation rental reservation and accepting entries 822 from the user's agent to persist items in the updatable itinerary for activities manually arranged by the user's agent.

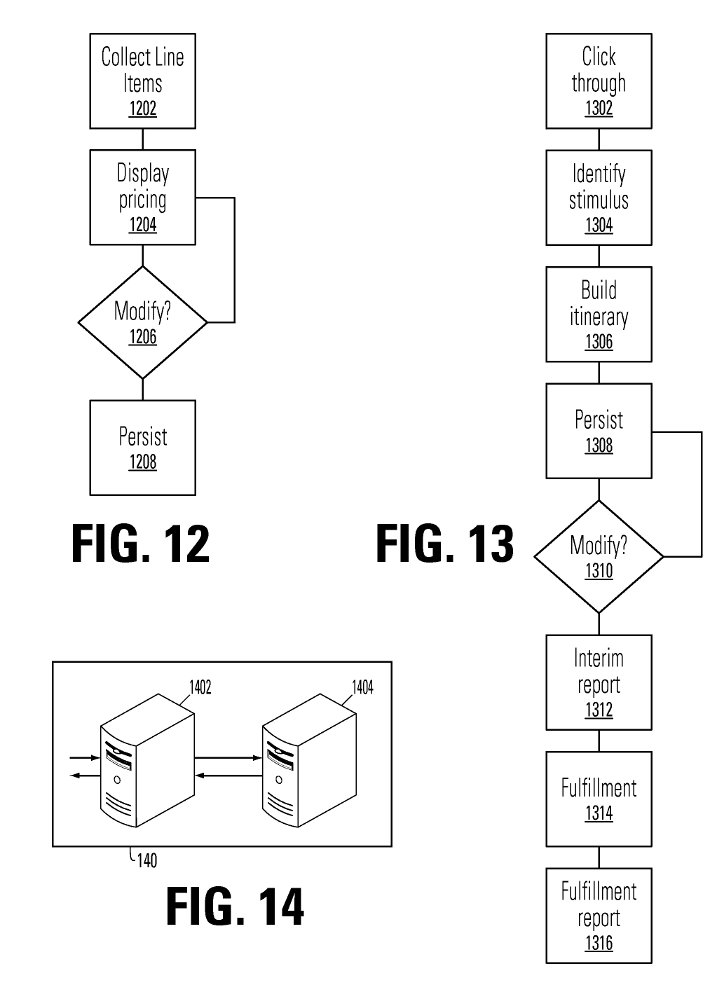

FIG. 12 is a high-level block diagram of dynamic packaging and pricing of travel. Dynamic package pricing is a further feature that can be provided either when a represented user has a user's agent conduct online negotiations, or when an intelligent software agent dynamically configures a package. The feature may stand alone or be combined with the other embodiments, aspects and features described. Focusing on the user's agent, the dynamic package pricing 1202 may include presenting the user's agent online in real time with a plurality of vendor offerings in different purchase categories and an option to select among the plurality of vendor offerings and combine them into a travel package. For at least selected vendor offerings, the method includes presenting the user's agent with offering prices and commissions payable at the offering prices 1204. The user's agent has the option to decrease or increase the price of the travel package 1206 and see the impact on the commissions payable, before quoting a price to the represented user. The method further includes persisting 1212 the travel package selected by the user's agent on the intermediator's server as part of the updatable itinerary. In this sense, the travel package includes a combination of vendor offerings, an overall price for the travel package and a total commissions payable at the overall price. If further may include line item prices for the vendor offerings in the travel package.

As an enhancement to either dynamic package pricing or to assembly of an updatable itinerary, the method may further include determining upgrade options 1208, 1210 with pricing information, persisting the upgrade options 1212 as part of the updatable itinerary and allowing the represented user to reopen negotiations by accepting one or more upgrade options. The upgrade options may be determined is matter of policy or by the user's agent.

Another feature, which is compatible with any of the aspects, modes or features of the methods above, includes tracking reopening of negotiations for items on the updatable itinerary through fulfillment. In a sense, fulfillment means at least passage of the scheduled date for the user to take a flight, occupy a unit, etc. Upon fulfillment 834, determined by reporting that the user took advantage of the reservation or by expiration of the last time for the user to seek a refund, the method may further include electronically reporting the fulfillment without cancellation to the vendors for payment of commissions. This is much different than many online booking services, such as hotel.com, because it allows for the reservation to be revised or canceled. Existing online booking services often have no-cancellation policies, so that they can immediately collect commissions as being earned. This creates a disincentive for users to take advantage of online booking services. Tracking the reservation through fulfillment and paying commissions after fulfillment should increase the flexibility that a user has to modify or cancel a reservation.

This method may be practiced in conjunction with a backend system that schedules and triggers activities supporting rental activity. For instance, the method may further include posting to a backend vacation rental management system 836 at least the dates for the vacation rental reservation, thereby triggering scheduling of services to prepare the vacation rental for arrival of the user.

A further aspect that can be used in various combinations with the foregoing aspects, modes or features involves travel insurance. The method may further including offering the user travel protection based on insurable items among the items of the updatable itinerary. This offering may be automatically limited based on protection allowed by a jurisdiction in which the vacation rental is located. More, it may be automatically limited based on protection allowed in a jurisdiction in which a contract is formed as a result of the negotiation for the vacation rental. Vacation rental protection may be offered on an opt-out or opt-in basis.

Tracking of the advertising effectiveness can be conducted in conjunction with embodiment described or as a separate embodiment. FIG. 13 is a high-level flowchart of tracking a user from click-through to fulfillment. The method embodiment described may further include receiving electronically at a website a referral of a user in response to advertising and determining from the electronically received referral an advertising stimulus 1304 leading to the user referral. For instance, advertising associated with words or categories purchased from an advertising vendor, such as a search engine vendor, attracts the user to click through for more information. When the user clicks 1302, the search engine invokes a URL provided by the entity that bought the advertising. A group of different URLs can all be redirected to a single handler, and differentiated by some coding carried with the URL 1304. In conjunction with intermediating online negotiations 1306, identifying the travel-related subject matter of interest, purchase categories and relevant vendors may be based on the user's click through. Persisting the updatable itinerary 1308 may include adding to the data structure an identification of the advertising stimulus. The updatable itinerary may be modified 1310, as described above. After a date for fulfillment 1314, the items on the updatable itinerary passes, the method may further include electronically reporting fulfillment without cancellation 1316 to the vendors for payment of commissions, with the identification of the advertising stimulus. Alternatively, the value of items in an updatable itinerary may be reported on an ongoing basis 1312. The value of a particular updatable itinerary associated with an advertising stimulus may be classified based on the status of fulfillment, such as fulfilled or not, aging since the last modification the itinerary, aging since the original establishment of the itinerary, or negative aging from fulfillment dates. In this context, reporting reveals the value of the advertising. Optionally, it may indicate that commissions are payable.

Standing by itself, an advertising tracking method may include receiving electronically at a website a referral of a user in response to advertising 1302 and determining from the electronically received referral an advertising stimulus leading to the user referral 1304. It may include initiating an intermediated online negotiation 1306 between the user and a particular vendor selected in response the advertising, including sending, receiving, channeling and persisting actions, as previously described, with persisting 1308 in the updatable itinerary data structure an identification of the advertising stimulus. The method further may include adding to the updatable itinerary 1308 as additional items results of additional intermediated online negotiations with one or more additional vendors in additional purchase categories. The updatable itinerary may be made available via a network to the user. After a date for fulfillment of the items on the itinerary passes 1314, fulfillment may be electronically reported 1316 to the vendors with identification of the advertising stimulus. Or, as above, the value of a particular updatable itinerary associated with an advertising status may be reported on an ongoing basis 1312, with or without classification. This may be combined with reporting that commissions are payable.

The methods described above may be carried out by a travel reservation database and system. The system may include a hub server coupled to an interface to the user. The hub server includes logic and resources to retrieve unit and travel-related service descriptions and to persist a reservation item for the unit or the travel-related service in an updatable itinerary data structure, responsive to user requests. Optionally, a dynamic webpage generation server may be coupled between the user and the hub server. The dynamic webpage generation server may include logic and resources adapted to respond to the user requests by generating webpages that present descriptions in the unit or of the travel service. Preferably, the dynamically generated webpages present the descriptions without loading the unit award travel related service descriptions into either a frame or IFame webpage structure. The database and system further include a unit availability database, including at least unit descriptions and availability, coupled to the hub server. Another component is a VRM unit maintenance server that provides a plurality of different VRM operators access to the unit availability database, including logic and resources to populate the unit availability database with the unit descriptions of units operated by the VRM operators. Other components are one or more reservation connectors that couple the hub server to a plurality of distinct data sources that list travel-related services and accept reservations for the listed travel-related services. The hub server is further coupled to an updatable itinerary database, in which the hub server persists confirmations of reservation items for the units and travel related services, using the updatable itinerary data structure. An updatable itinerary access server, coupled between the network and the updatable itinerary database, includes logic and resources to generate a user interface page including a formatted version of the items in a particular updatable itinerary data structure, with at least one control for adding (alternatively, for changing) an item in the particular updatable itinerary data structure. This user interface page may be presented as webpage or as an HTML message, such as an e-mail message. The logic and resources of the updatable itinerary access server may further invoke the hub server in a session separate from when reservation items originally were persisted in the particular updatable itinerary data structure, responsive to a message indicating a user's selection of the control for adding (or changing) the item. The hub server adds (or changes) reservation items in the particular updatable itinerary data structure.

A further aspect of the database and system described above includes a first interface to the hub server adapted to be used by professional agent who initially instructs the hub server to add reservation items to the updatable itinerary data structure and an e-mail delivery component that sends the user interface page to a traveler for whom the professional agent added the reservation items. Optionally, security settings may allow the traveler to invoke the hub server and add additional reservation items to the particular updatable itinerary data structure, such that the additional reservation items are viewable online by the traveler but not by the professional agent.

FIG. 14 is a high-level block diagram of equipment used for integrating into a website at a first address catalog content hosted at a second address. This method includes encoding the first webpage of the first website to invoke server-side code responsive to a request for the first webpage. (See CD-ROM source code.) The server-side code is adapted to dynamically update content of the first webpage. Upon receiving a request for the first webpage, the content of the first webpage is dynamically updated. This process includes invoking the server-side code 1402 and emulating a browser by making a request to a content server 1404 hosted at the second URL, effectively requesting data to be returned as an HTML page. Upon receiving the HTML page from the second URL, wrapper tags are removed, leaving the requested data in HTML format. The first webpage is dynamically updated by inserting the requested data in HTML format . The dynamically updated first webpage is sent in response to the request. While FIG. 14 illustrates two servers, a server can host multiple websites, so the combined TS Hub 140 functions can run on a single server. The content server may be involved using a different addressing mechanism, instead of URLs, such as an IP address, URI, URN, MAC address, object name or memory address.

Of interest, when the request for the first webpage is received from an indexing process, for instance, for a search engine, the dynamically updated first webpage presents the requested catalog data as part of the first webpage without demarcations that would result in the indexing process excluding the requested data from indexing. Typically, this means that many requested data is not demarked with frame or IFrame tags.

The search engine optimization aspects of this method may be extended by further repeating the encoding process for a plurality of webpages in the website at the first URL and, in at least the top two levels of the website at the first URL, including a plurality of pages that dynamically update the content of the webpages from the second URL and that present individual catalog listings in multiple data cross sections, thereby increasing a count of links in the first two levels of the website and a count of exposures for indexing of the individual catalog listings.

This second method embodiment also may be practiced as a dynamic webpage generation server. The dynamic webpage generation server operates on and is adapted to retrieve webpages including content conveyor objects, responsive to the user request. The content conveyor objects typically are coded as tags. A browser emulation component operatively coupled to the webpage generation server includes logic and resources adapted to interpret the content conveyor objects and request HTML pages from a content server. The browser emulation component is further adapted to receive content from the content server. A dynamic merge component operatively coupled to the browser emulation and the dynamic webpage generation server includes logic and resources adapted to strip away wrapper tags, leaving HTML text and insert the HTML text in the place of the content conveyer object in the webpage. Typically, no frame or IFrame tags border the inserted HTML text. In fact, operation of the merge component may not leave any artifacts that would indicate that text has been retrieved from the content server or that any merge component had operated on the webpage. The result is a dynamically updated webpage in memory that is ready to serve in response to a request.

It is contemplated that modifications and combinations will readily occur to those skilled in the art, which modifications and combinations will be within the spirit of the invention and the scope of the following claims.

### Glossary

Vacation Rental Unit—a private residence, privately owned condominium or other lodging that includes a kitchen and is located in a vacation destination

Vacation Rental Traveler—individual, family or other entity which rents a rental unit from a vacation rental manager

Vacation Rental Manager (VRM)—A business or individual who engages in the activity of renting vacation rental units to travelers. A VRM employee selling to a user is described as a user representative.

Vacation Rental Owner—An individual or small company who directly owns a vacation rental unit; the vacation rental owner may or may not employ the services of a vacation rental manager to manage the vacation rental unit

VRM Edition/VRM Software—The management software developed by Rent One Online for use by vacation rental managers; instances in this document which refer specifically to the VRM software shall generally include the PVRM software edition

PVRM Edition/PVRM Software—Management with similar functionality which shares a common codebase with the VRM edition targeted at smaller vacation rental managers and vacation rental owners; uses a shared database where the VRM edition has a dedicated database for each customer

TS Hub—An internal term which represents the linking of multiple Travel Services; holds the fundamental information about the traveler(s)

Rental Finder—An internal term which refers to the process of publishing information on vacation rental units, availability, pricing and other information to Travel Services as well as searching that information and making an inquiry or booking the unit online

Air Finder—An internal term which refers to all technology, interfaces and protocols used to purchase airline tickets through Travel Services

Car Finder—An internal term which refers to all technology, interface and protocols used to purchase car rentals through Travel Services

Activity Finder—An internal term which refers to all technology, interface and protocols used to purchase activities through Travel Services which may include, but are not limited to airport parking, golf tee times, tours, cruises, local activities and events

Integrated itinerary/Live Itinerary 24/7—An itinerary which consists of all of the various parts of the vacation purchased by a traveler through Travel Services; may be available online, in print, or via other media; may allow for changes to various items as well as additions to those items.

We claim as follows:

1. A travel reservation database and system, including:
a dynamic web page generation server coupled to a network, including logic and resources adapted to respond to a user request by generating web pages that present descriptions of a unit or a travel service without loading the unit or travel-related service descriptions into frame or IFrame web page structures;
a hub server coupled by the dynamic web page generation server to the user, the hub server including logic and resources to retrieve unit and travel-related service descriptions and to persist a reservation item for the unit or the travel-related service in an updatable itinerary data structure, responsive to user requests;
a unit availability database, including at least unit descriptions and availability, coupled to the hub server;
a VRM unit maintenance server that provides a plurality of different VRM operators access to the unit availability database, including logic and resources to populate the unit availability database with the unit descriptions of units operated by the VRM operators;
one or more reservation connector components that couple the hub server to a plurality of distinct data sources that list travel-related services and accept reservations for the listed travel-related services;
an updatable itinerary database, coupled to the hub server, in which the hub server persists confirmations of reservation items for the units and travel-related services, using the updatable itinerary data structure; and
an updatable itinerary access server, coupled between the network and the updatable itinerary database, including logic and resources to
generate a user interface page including a formatted version of items in a particular updatable itinerary data structure, with at least one control for adding an item to the particular updatable itinerary data structure; and
invoke the hub server in a session separate from when reservation items originally were persisted in the particular updatable itinerary data structure, responsive to a message indicating user selection of the control for adding the item, the hub server adding additional reservation items to the particular updatable itinerary data structure.

2. The database and system of claim 1, wherein the logic and resources of the updatable itinerary access server is further adapted to:
generate the user interface page including, for at least one confirmed reservation item, a control for changing the confirmed reservation item in the updatable itinerary data structure; and
invoke the hub server in a session separate from when reservation items originally were persisted in the particular updatable itinerary data structure, responsive to a message indicating user selection of the control for changing the confirmed reservation item, the hub server relaying to the user terms for changing the item, relaying to a vendor for the confirmed reservation item an acceptance of the terms for changing the item and persisting a confirmation of a changed reservation item in the updatable itinerary data structure.

3. The database and system of claim 1, further including:
a first interface to the hub server adapted to be used by a professional agent who initially instructs the hub server to add reservation items to the updatable itinerary data structure;
an e-mail delivery component that sends the user interface page to a traveler for whom the professional agent added the reservation items; and
security settings that allow the traveler to invoke the hub server and add additional reservation items to the particular updatable itinerary data structure, such that the additional reservation items that are viewable online to the traveler but not by the professional agent.

4. The database and system of claim 1, further including:
a dynamic package pricing component of the hub server adapted to be used by a professional agent who initially instructs the hub server to add reservation items to the updatable itinerary data structure, including logic and resources that
provide line item prices and commission calculations for the unit and the travel-related services;
accept at least an overall discounted price selected by the professional agent; and
persist the overall discounted price with the updatable itinerary data structure.

5. A method of persisting and updating an updatable itinerary data structure that records online negotiations between a consumer and multiple distinct travel-related vendors, including:
identifying a travel-related subject matter of interest;
identifying purchase categories within the travel-related subject matter;
for at least two particular purchase categories, identifying one or more relevant vendors;
in a first network session, intermediating negotiation online between a user or user's agent (collectively referred to as the user) and at least first and second vendors in different purchase categories, the first and second vendors being distinct, including for a vendor
sending the user the vendor's offerings, including availability and pricing;
receiving the user's selection of a particular offering;
channeling messages between the vendor and the user;
persisting, as an item in memory of an intermediator's server, confirmation of the intermediated negotiation, the item forming part of an updatable itinerary data structure;
in a second network session with the user, accessing the updatable itinerary data structure and sending the user a formatted version of items in the updatable itinerary data structure with at least one control for adding an item;
responsive to a message indicating selection of the control for adding the item, repeating the sending, receiving, channeling and persisting actions, thereby adding to the updatable itinerary data structure, as additional items, confirmations of additional intermediated online negotiations with one or more additional vendors.

6. The method of claim 5, further including persisting in the updatable itinerary a vacation rental reservation, meaning a rental of a vacation home, beach house or condominium, as a result of one of the intermediated online negotiations.

7. The method of claim 5, wherein the intermediator is licensed as a travel agent and aggregates billing of multiple items to the user in a single charge.

8. The method of claim 5, wherein a first intermediated negotiation, meaning before other items are added to the updatable itinerary, is for a vacation rental reservation, meaning a rental of a vacation home, beach house or condominium.

9. The method of claim 8, wherein adding to the updatable itinerary further includes presenting the user additional purchase category offerings that are geographically proximate to a location of the vacation rental reservation.

10. The method of claim 9, wherein presenting geographically proximate additional purchase category offerings further includes identifying at least one airport that is geographically proximate to the location of the vacation rental reservation and presenting at least one airport-related purchase category in the context of the identified airport.

11. The method of claim 8, further including in the updatable itinerary for one or more travelers' age information and further including presenting the user activity offerings that are appropriate to the travelers' age information.

12. The method of claim 8, wherein a represented user has a user's agent conducts the online negotiations and the updatable itinerary is made available to both the represented user and the user's agent.

13. The method of claim 12, further including collecting from the user's agent additional helpful information and persisting it in the updatable itinerary to be viewed by the represented user.

14. The method of claim 12, further including supporting the user's agent in arrangement of activities that are not bookable online, including
presenting online for the user's agent activity options consistent with dates for the vacation rental reservation; and
accepting entries from the user's agent to persist items in the updatable itinerary for activities manually arranged by the user's agent.

15. The method of claim 12, further including:
presenting the user's agent online in real time with
a plurality of vendor offerings in different purchase categories,
an option to select among the plurality of vendor offerings and combine them into a travel package,
offering price information for at least selected vendor offerings,
commissions payable to the user's agent at the offering prices, and
an option to price the travel package at a cost that changes the commissions payable to the user's agent; and
persisting the travel package selected by the user's agent on the intermediator's server as part of the updatable itinerary, the travel package including a combination of the vendor offerings, an overall price for the travel package, line item prices for the vendor offerings in the travel package and a schedule of commissions payable to the user's agent.

16. The method of claim 15, further including;
collecting from the user's agent upgrade options with pricing information;
persisting the upgrade options as part of the updatable itinerary;
wherein reopening negotiations further includes allowing the represented user to accept the upgrade options.

17. The method of claim 12, further including:
automatically tracking reopening of negotiations for the items on the updatable itinerary through fulfillment; and
electronically reporting the fulfillment without cancellation to the particular and additional vendors for payment of commissions.

18. The method of claim 12, further including posting to a backend vacation rental management system the vacation rental reservation, thereby triggering scheduling of services to ready the vacation rental for arrival of the represented user.

19. The method of claim 8, further including offering the user travel protection based on insurable items among the items on the updatable itinerary.

20. The method of claim 19, further including automatically limiting the offering of the travel protection based on protection allowed by a jurisdiction in which the vacation rental is located.

21. The method of claim 19, further including automatically limiting the offering of the travel protection based on protection allowed by a jurisdiction in which a contract is formed as a result of the negotiation for the vacation rental.

22. The method of claim 19, wherein the user's agent conducts the online negotiations on behalf of a represented user and the updatable itinerary is maintained available to both the represented user and the user's agent.

23. The method of claim 22, further including the represented user adding to the updatable itinerary further items that are maintained as available to the represented user for reference and renegotiation, but not available to the user's agent.

24. The method of claim 22, wherein the travel protection is presented to the user on an opt-out basis.

25. A method of persisting and updating an updatable itinerary data structure that records online negotiations and renegotiations between a consumer and multiple independent travel-related vendors, including:
identifying a travel-related subject matter of interest;
identifying purchase categories within the travel-related subject matter;
for at least two particular purchase categories, identifying one or more relevant vendors;
in a first network session, intermediating negotiations online between a user or user's agent (collectively referred to as the user) and at least first and second vendors in different purchase categories, the first and second vendors being distinct, including for a vendor
sending the user the vendor's offerings, including availability and pricing;
receiving the user's selection of a particular offering;
channeling messages between the vendor and the user;
persisting, as an item in memory of an intermediator's server, confirmation of the intermediated negotiation, the item forming part of an updatable itinerary data structure;
in a second network session with the user, accessing the updatable itinerary data structure and sending the user a formatted version of items in the updatable itinerary data structure with at least one control for renegotiating an item;
responsive to a message indicating selection of the control for renegotiating the item, reopening negotiation between the user and at least one vendor; and
intermediating renegotiation online by repeating the sending, receiving, channeling and persisting actions, thereby changing the renegotiated item and adding a confirmation of the renegotiation to the updatable itinerary data structure.

26. The method of claim 5, adapted to track advertising, further including:
receiving electronically at a web site a referral of the user in response to advertising;
determining from the electronically received referral an advertising stimulus leading to the user referral;
wherein identifying the travel-related subject matter of interest, the purchase categories and the relevant vendors is based on the user referral;
persisting in the updateable itinerary data structure an identification of the advertising stimulus; and
after a date for fulfillment of the items on the itinerary passes, electronically reporting fulfillment without cancellation to the vendors with the identification of the advertising stimulus.

27. A method of tracking effective response to travel advertising through fulfillment, including:
receiving electronically at a web site a referral of a user in response to advertising;
determining from the electronically received referral an advertising stimulus leading to the user referral;
initiating an intermediated online negotiation between the user and a particular vendor selected in response to the advertising, including
sending the selected vendor's offerings, including availability and pricing;
receiving a selection of a particular offering;
channeling messages between the selected vendor and the user;
persisting as an item in memory of an intermediator's server confirmation of the intermediated negotiations, the item forming part of an updatable itinerary, and an identification of the advertising stimulus;
adding to the updatable itinerary as additional items results of additional intermediated online negotiations with one or more additional vendors in additional purchase categories;
making availability via a network of the updatable itinerary to the user; and
after a date for fulfillment of the items on the updatable itinerary passes, electronically reporting fulfillment without cancellation to the vendors with the identification of the advertising stimulus.

28. The method of claim 27, further including distinguishing among sale of advertised items, substitute items, and complementary items in the electronic reporting.

29. The method of claim 27, further including periodically reporting value of the items on the itinerary with the identification of the advertising stimulus, prior to dates for fulfillment.

30. A dynamic webpage generation server, including:
at least one webpage including at least one content conveyer object contained in memory accessible to the dynamic webpage generation server, wherein parameters of the content conveyer object specify a content server and parameters to pass the content server;
a browser emulation component coupled to the webpage generation server that includes logic and resources adapted to
request an HTML page from the content server specified in the content conveyer object; and
receive the HTML page from the content server;
a dynamic merge component operatively coupled to the browser emulation component and the dynamic webpage generation server that includes logic and resources adapted to
strip away wrapper tags from the HTML page, leaving an HTML text; and
insert the HTML text in place of the content conveyer object in webpage, thereby producing a dynamically updated webpage; and
a publishing component operatively coupled to the browser dynamic merge component and the dynamic webpage generation server including logic and resources that, responsive to a request message, retrieve the at least one webpage, invoke the browser emulation component, invoke the dynamic merge component, and publish a dynamically updated webpage.

31. A method of integrating into a web site at a first URL catalog content hosted at a second URL, including:
encoding a first web page of the first web site to invoke server side code responsive to a request for the first web page, the server side code adapted to dynamically update content of the first web page;
upon receiving a request for the first web page, dynamically updating content of the first web page, including
invoking the server side code;
emulating a browser making a request to a catalog content server hosted at the second URL and requesting data to be returned as an HTML page;
receiving the HTML page from the second URL and removing wrapper tags, leaving the requested data in HTML format;
dynamically updating the content of the first web page by inserting the requested data in HTML format into the first web page; and
returning the dynamically updated first web page responsive to the request.

32. The method of claim 30, wherein the request for the first web page is received from an indexing process and the dynamically updated first web page presents the requested data as part of the first web page without demarcations that would result in the indexing process excluding the requested data from indexing.

33. The method of claim 32, further including:
repeating the encoding process for a plurality of web pages in the web site at the first URL; and
in two top levels of the web site at the first URL, including a plurality of web pages that dynamically update the content of the web pages from the second URL, and that present individual catalog listings in multiple data cross sections, thereby increasing a count of links in the first two levels of the web site and a count of exposures for indexing of the individual catalog listings.
